(19) United States
(12) Patent Application Publication
(10) Pub. No.: US 2018/0060144 A1
(43) Pub. Date: Mar. 1, 2018

(54) CONTROL METHODS FOR MOBILE ELECTRONIC DEVICES IN DISTRIBUTED ENVIRONMENTS

(71) Applicant: SNAPBACK S.r.l., Rome (IT)

(72) Inventors: Claudio CAPOBIANCO, Rome (IT); Paoio PERRUCCI, Rome (IT); Moreno DE VINCENZI, Tivoli Terme, Rome (IT); Giuseppe MORLINO, Potenza (IT); Ester VIGILANTE, Rome (IT); Gerardo GORGA, Vietri di Potenza (IT)

(21) Appl. No.: 15/543,239

(22) PCT Filed: Jan. 14, 2016
(86) PCT No.: PCT/IL2016/050046

§ 371 Date: Jul. 13, 2017

Related U.S. Application Data
(60) Provisional application No. 62/103,593, filed on Jan. 15, 2015.

(51) Int. Cl. G06F 9/54; G06F 3/01; G06K 9/00; G06F 3/0346; G06F 1/16

(52) U.S. Cl. CPC G06F 9/542; G06F 3/017; G06K 9/00335; G06T 3/0012; G06F 1/1613; G06F 9/541; G06F 3/0346

(57) ABSTRACT

The present invention provides methods and systems for controlling electronic devices through digital signal processor (DSP) and handler control logic. DSPs and handlers are connected by at least one signal adapter, with each signal adapter making use of partial DSP functionalities, and at least one device sensor. The present invention makes use of a device profiling database, to optimize device performance.

### CROSS REFERENCES TO RELATED APPLICATIONS

This patent application is related to and claims priority from commonly owned U.S. Patent Application Ser. No. 62/103,593, entitled: CONTROL METHODS FOR MOBILE ELECTRONIC DEVICES IN DISTRIBUTED ENVIRONMENTS, filed on Jan. 15, 2015, the disclosure of which is incorporated by reference in its entirety herein.

### TECHNICAL FIELD

The present invention relates to methods and systems to control one or more electronic devices through signal processing and control logic.

### BACKGROUND OF THE INVENTION

Technology has made great steps forward in creating portable and full-featured devices. Unfortunately, the user interfaces are not evolving at the same pace, as most mobile user interfaces are based on buttons, touch screens, or voice.

Attempts have been made to use sensors in the devices. However, these efforts have been limited by the complexity of signal processing hardware and software. Existing software libraries address only specific sensors, such as computer vision or speech recognition.

Using more software libraries in the same application has high costs. Additionally, this typically gives rise to incompatibility issues.

Other sensors, such as cameras or microphones, consume large amounts of battery power, and therefore, are not suitable for prolonged use on a mobile device. Oppositely, solutions based on low-energy sensors, such as accelerometers or proximity sensors, provide minimal information.

### SUMMARY OF THE INVENTION

The present invention relates to methods for electronic devices to receive inputs via sensors and process digital signals from the sensors. Based on a combination of those inputs, as processed by the device, the device issues notifications, such as commands and signals, to software applications.

Embodiments of the present invention include a digital signal processor (DSP) component, a handler control logic, and a set of inputs from a variety of sensors. The DSP component communicates with the handler control logic by a signal adapter.

Embodiments of the present invention are directed to a method for activating an application. The method comprises: receiving a request, for example, an event request, for at least one first group of events, from at least one application, the application for example, being a software application; receiving sensor input from at least one sensor having detected, or otherwise obtained, at least one event; converting the sensor input into data corresponding to the detected (or obtained) at least one event; associating the data corresponding to each detected event into at least one second group of events; analyzing the at least one second group of events with the at least one first group of events associated with the request, for determining a correlation therebetween; and, transmitting a response when there is a correlation between the at least one second group of events and the at least one first group of events associated with the request.

Optionally, the at least one first group of events is based on a pattern of events.

Optionally, the analyzing the at least one second group of events with the at least one first group of events for the correlation therebetween includes analyzing the events of the at least one second group of events with pattern of events, for the correlation.

Optionally, the correlation includes matches of the at least one second group of events with the at least one first group of events associated with the request, to at least a predetermined threshold.

Optionally, the correlation includes matches of the at least one second group of events with the pattern of events, to at least a predetermined threshold.

Optionally, the converting the sensor input into data corresponding to detected events, includes processing the sensor input into signals and converting the signals into the data corresponding to the detected events.

Optionally, the at least one sensor includes a plurality of sensors.

Optionally, the sensors of the plurality of sensors include one or more of: accelerometers, acceleration sensors, gyroscopes, gyrometers, magnetometers, microphones, proximity sensors, ambient light sensors, Global Positioning System (GPS) sensors, hall effect sensors, magnetic sensors, physical keys on a device touch screen, touch sensors, and, headphone command sensors.

Optionally, the aforementioned method is performed on a computerized device.

Optionally, the computerized device is selected from at least one of a smart phone, smart watch, smart band, including a smart wrist band.

Optionally, the at least one application is on the computerized device, and, for example, is running and/or executing on the device.

Optionally, the computerized device performing the method for activating the application is analyzed to optimize the performance of the at least one sensor for receiving the sensor input.

Optionally, the computerized device performing the method for activating the application is analyzed to optimize the power allocation in the computerized device during the performing the method for activating the application.

Optionally, the at least one first group of events and the at least one second group of events each include at least one event.

Optionally, the at least one first group of events and the at least one second group of events each include a plurality of events.

Optionally, the event includes at least one of: a hand gesture, including a hand wave, finger snap or a hand being stationary for a predetermined time period or at a predetermined distance from a reference point, a blow of breath, acceleration of a device, speed of a device, a device position, a device orientation with respect to a reference point, a device location, contact with a touch screen of a device, contact with a physical key of a device, and combinations thereof.

Optionally, the pattern of events is defined by predetermined events.

Other embodiments of the present invention are directed to a system for activating an application. The system comprises: at least one sensor for detecting events, a digital signal processor (DSP) and handler control logic. The digital signal processor (DSP) is in communication with the at least one sensor, and the DSP is configured for: 1) receiving sensor input from at least one sensor having detected at least one event; 2) converting the sensor input into data corresponding to the detected at least one event; and, 3) associating the data corresponding to each detected event into at least one second group of events. The handler control logic is in communication with the digital signal processor (DSP) configured for: 1) receiving a request, for example, an event request, for at least one first group of events, from at least one application; 2) analyzing the at least one second group of events with the at least one first group of events associated with the request, for determining a correlation therebetween; and, 3) transmitting a response when there is a correlation between the at least one second group of events and the at least one first group of events associated with the request.

Optionally, in the system, the at least one first group of events is based on a pattern of events, and the handler control logic is additionally configured for analyzing the at least one second group of events with the pattern of events, for determining a correlation therebetween.

Optionally, in the system, the handler control logic is programmed to determine the existence of a correlation when there are matches of the at least one second group of events with the at least one first group of events associated with the request, to at least a predetermined threshold.

Optionally, in the system, the handler control logic is programmed to determine the existence of a correlation when there are matches of the at least one second group of events with the pattern of events, to at least a predetermined threshold.

Optionally, in the system, the DSP is additionally configured for: converting the sensor input into data corresponding to detected events, includes processing the sensor input into signals and converting the signals into the data corresponding to the detected events.

Optionally, in the system, the at least one sensor includes a plurality of sensors.

Optionally, in the system, the sensors of the plurality of sensors include one or more of: accelerometers, acceleration sensors, gyroscopes, gyrometers, magnetometers, microphones, proximity sensors, ambient light sensors, Global Positioning System (GPS) sensors, hall effect sensors, magnetic sensors, physical keys on a device touch screen, touch sensors, and, headphone command sensors.

Optionally, the system is located on a computerized device.

Optionally, in the system, the computerized device is selected from at least one of a smart phone, smart watch, smart band, including a smart wrist band.

Optionally, in the system, the at least one application is on the computerized device, and, for example, is running and/or executing on the device.

Optionally, the system additionally comprises a profiling database in communication with at the at least one sensor, the profiling database configured for optimizing the performance of the at least one sensor for receiving the sensor input.

Other embodiments of the present invention are directed to a computer usable non-transitory storage medium having a computer program embodied thereon for causing a suitable programmed system to activate an application on a device, by performing the following steps when such program is executed on the system. The steps comprise: receiving a request (e.g., an event request) for at least one first group of events, from at least one application; receiving sensor input from at least one sensor having detected (or otherwise obtained) at least one event;
converting the sensor input into data corresponding to the detected at least one event; associating the data corresponding to each detected event into at least one second group of events; analyzing the at least one second group of events with the at least one first group of events associated with the request, for determining a correlation therebetween; and, transmitting a response when there is a correlation between the at least one second group of events and the at least one first group of events associated with the request.

Optionally, the computer usable non-transitory storage medium is such that the at least one first group of events is based on a pattern of events.

Optionally, the computer usable non-transitory storage medium is such that the analyzing the at least one second group of events with the at least one first group of events for the correlation therebetween includes analyzing the events of the at least one second group of events with pattern of events, for the correlation.

Optionally, the computer usable non-transitory storage medium is such that the correlation includes matches of the at least one second group of events with the at least one first group of events associated with the request, to at least a predetermined threshold.

Optionally, the computer usable non-transitory storage medium is such that the correlation includes matches of the at least one second group of events with the pattern of events, to at least a predetermined threshold.

Optionally, the computer usable non-transitory storage medium is such that the converting the sensor input into data corresponding to detected events, includes processing the sensor input into signals and converting the signals into the data corresponding to the detected events.

The following terminology is used throughout this document.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned.

The terms “device”, “electronic device”, “computerized device”, and, “computer device” are used interchangeably herein in this document and are a type of “computer” as defined immediately above, and include mobile devices that can be readily transported from one location to another location (e.g., Smartphone, personal digital assistant (PDA), mobile telephone or cellular telephone, wearable devices, such as smart bands (wristbands) and smart watches), as well as personal computers (e.g., laptop, desktop, tablet computer, including iPads).

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application” or “software application”, includes executable software, and optionally, any graphical user interfaces (GUI), through which certain functionality may be implemented.

A “client” is an application that runs on a computer, workstation or the like and relies on a server to perform some of its operations or functionality.

“n” and “nth” refer to the last member of a varying or potentially infinite series.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A is a diagram showing an example environment for the invention;

FIG. 1B is an illustration of the overall architecture of the present invention, when incorporated into a computerized device;

FIG. 2 is a flow diagram of the process for the initialization of present invention;

FIG. 3 is a flow diagram of the subprocess from the input sensor signals to the handler queue;

FIG. 4 is a flow diagram of the subprocess from the handler queue to the notification to a software application;

FIG. 5 is a diagram of an exemplary system on which an embodiment of the present invention is performed, with a single electronic device;

FIG. 6 is a diagram of an exemplary system on which an embodiment of the present invention is performed, with a single electronic device and DSP integrated into a dedicated chip;

FIG. 7 is a diagram of a second exemplary system on which an embodiment of the present invention is performed, with a single electronic device, DSP integrated in the CPU and handler control logic integrated into the OS (Operating System);

FIG. 8 is a diagram of a third exemplary system on which an embodiment of the present invention is performed, with an auxiliary electronic device;

FIG. 9 is a diagram of a full stack in accordance with embodiments of the present invention;

FIG. 10 is a diagram of a signal adapter conversion from DSP output to an events queue in accordance with embodiments of the present invention;

FIG. 11 is a diagram of a handler recognizing a short pulse pattern and issuing a short pulse notification, in accordance with embodiments of the invention;

FIG. 12 is a diagram of a handler recognizing a double pulse pattern and issuing the double pulse notification, in accordance with embodiments of the present invention;

FIG. 13 is a diagram of a handler recognizing the long pulse and long pulse repeating patterns and issuing the relative notifications, in accordance with embodiments of the present invention;

FIG. 14 is a system diagram for the population and utilization of the profiling database, in accordance with embodiments of the present invention;

FIG. 15 is a flow diagram of an example process performed by the system of FIG. 14.

FIG. 16A-1 is a diagram showing a user interacting with a device to perform a process in accordance with embodiments of the present invention;

FIG. 16A-2 is a flow diagrams of an example process of operating a media player initiated by the user in FIG. 16A-1;

FIGS. 16B-1 is a diagram showing a user interacting with a device to perform a process of operating a navigator in accordance with embodiments of the present invention;

FIG. 16B-2 is a flow diagrams of an example process initiated by the user in FIG. 16B-1;

FIG. 16C is a diagram of a process to perform a telephone call in accordance with embodiments of the present invention;

FIGS. 17A, 17B and 17C is a flow diagram of an example process of a second automotive application or service, in accordance with embodiments of the present invention;

FIG. 18 is a flow diagram of an example process of an application for cooking, in accordance with embodiments of the present invention;

FIGS. 19A-1 and 19A2 are diagrams showing a user interacting with a device to perform an example maintenance process in accordance with embodiments of the present invention; and,

FIG. 19B is a flow diagram of the maintenance process of FIGS. 19A-1 and 19A-2, in accordance with embodiments of the present invention.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

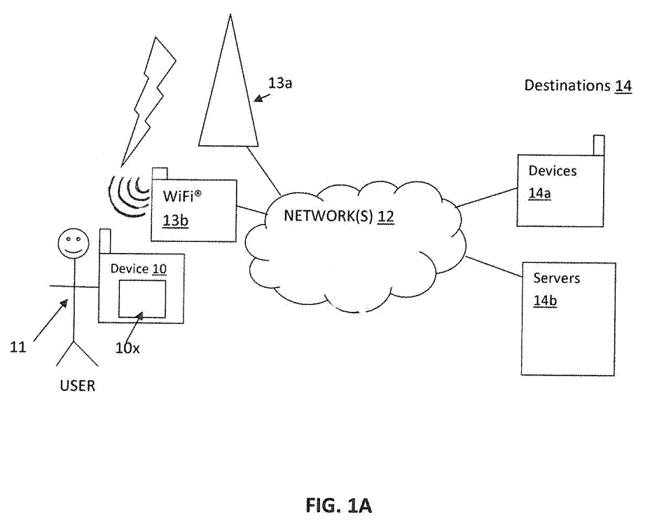

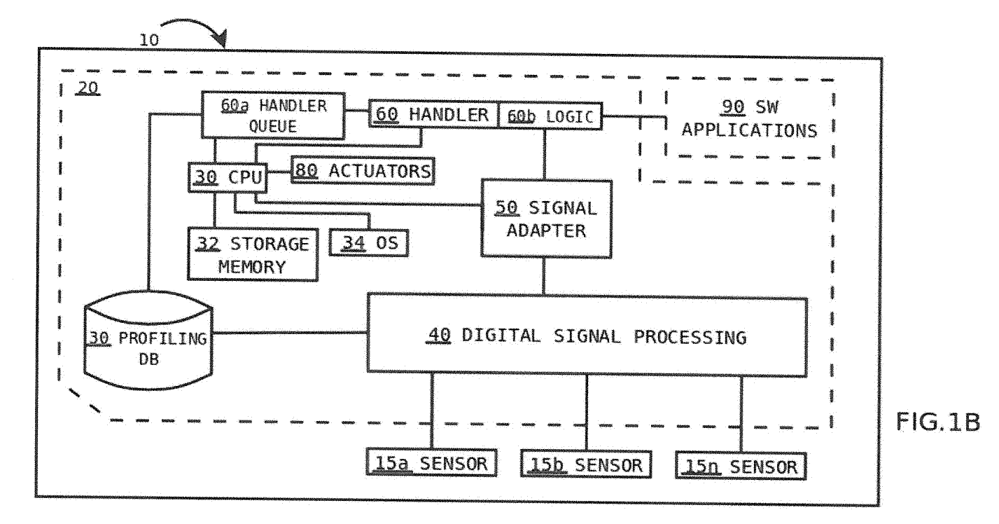

Reference is now made to FIG. 1A, which shows a computerized device 10 of a user 11, operable with one or more network(s) 12, which link the device 10 to various destinations 14, such as devices 14a and servers 14b, linked to the network(s) 12 or other networks linked to the network(s) 12. The computerized device 10, is, for example, a cellular telephone, such a smart phone, and includes a screen 10x which provides a visual object display, and, for example, is a touch screen, responsive to user contacts with the screen 10x. The device 10 accesses one or more of the network(s) 12, for example, by a cellular tower 13a, or a WiFi® hotspot 13b. The network(s) 12 is, for example, a communications network, such as a Local Area Network (LAN), or a Wide Area Network (WAN), including public networks such as the Internet. The network(s) 12 is either a single network or a combination of networks and/or multiple networks, including also (in addition to the aforementioned communications networks such as the Internet), for example, cellular networks. “Linked” as used herein includes both wired or wireless connections, either direct or indirect, and, for example, placing the device 10 in electronic and/or data communication with the network(s) 12, as well as other devices, computers, and components of the network(s) 12 or other connected networks.

FIG. 1B is an illustration of the overall architecture 20 of the present invention, as used, for example, in the computerized device 10. The architecture 20, for example, forms a “system” for the device 10.

The architecture 20 includes a Central Processing Unit (CPU) 30, connected to storage/memory 32, where machine executable instructions are stored for operating the CPU 30, and the device operating system (OS) 34. The architecture 20 also includes a digital signal processor (DSP) or DSP unit 40 (DSP and DSP unit used interchangeably herein). The DSP 40, is, for example, designed to process digital signals, for example, those received from sensors 15a-15n, which detect various conditions, for example, the blowing of breath (blowing) toward the device 10 by the user 11. The DSP 40, for example, processes the aforementioned signals from the sensors 15a-15n in three phases: a detection phase that recognizes microphone saturation; a tracking phase that estimates sound pressure; and, a control logic phase, that places relative weights of estimations to recognize only blow-like signals. The sensors 15a-15n, OS 34, digital signal processor 40, signal adapter 50, handler 60, handler queue 60a, profiling database 70, and actuators 80, are linked either directly or indirectly to the CPU 30, so as to be controlled by the CPU 30. The architecture 20 or “system”, also includes software application(s) 90, which have been downloaded, for example, from a server, for example, represented by the servers 14b, linked to the Internet, e.g., network(s) 12, or other communications network, or otherwise programmed into the device 10.

The Central Processing Unit (CPU) 30 is formed of one or more processors, including microprocessors, for performing the device 10 functions and operations detailed herein, including controlling the storage/memory 32, Operating System (OS) 34 sensors 15a-15n, DSP 40, signal adaptor 50, handler 60, including the handler queue 60a and handler control logic 60b, profiling database 70, actuators 80, and at least portions of the software application(s) 90, along with the processes and subprocesses detailed below. The processors are, for example, conventional processors, such as those used in servers, computers, and other computerized devices. For example, the processors may include x86 Processors from AMD and Intel, Xenon® and Pentium® processors from Intel, as well as any combinations thereof.

The storage/memory 32 is any conventional storage media. The storage/memory 32 stores machine executable instructions for execution by the CPU 30, to perform the processes of the invention. The storage/memory 32 includes machine executable instructions associated with the operation of the CPU 30, and other components of the device 10, and all instructions for executing the processes detailed below. The storage/memory 32 also, for example, stores rules and policies for the device 10 and its system (architecture 20). The processors of the CPU 30 and the storage/memory 32, although shown as a single component for representative purposes, may be multiple components.

The Operating System (OS) 34 is, for example, a device operating system, such as Windows® from Microsoft, Inc. of Redmond, Wash., Android, and iOS, from Apple of Cupertino, Calif.

As stated above, the DSP 40 receives signals from, for example, sensors 15a-15n, processes the signal(s), and provides the processed signal, as an input signal, to a signal adapter 50. The signal adapter 50 extracts data from the input signal, and passes it to the handler 60, via the queue 60a of the handler 60. The handler 60 includes control logic 60b, which processes incoming data, e.g., the input from the signal adapter 50, and searches for patterns, for example, patterns of events, as detected by the sensors 15a-15n. Should the handler 60, by its control logic 60b detect, by correlating, such as matching, for example, correlating or matching to at least a predetermined threshold (for example, programmed into the control logic 60b or set as a device 10 rule or policy for the control logic 60b), events obtained via the sensors 15a-15n, to predetermined event(s), groups of events, and/or patterns (which are formed of events) from a software application 90, and which are required by the software application 90, the handler 60 issues and transmits (sends) a notification command to one or more software applications 90, running and otherwise executing on the device 10. The handler 60 and DSP 40 are linked, both electronically and data, to a device profiling database 70, in order to optimize performance of the device 10, including, for example, sensor 15a-15n performance, (DSP) algorithms reliability and accuracy, and device power allocation, in which they are running. There is also an actuator 80, for example the screen or the speaker of the device, or the Wi-Fi®, Bluetooth or GSM (Global System for Mobile Communications) antennas to communicate with servers or other devices.

The sensors 15a-15n are of multiple types, for example, accelerometers and other acceleration sensors, gyroscopes (gyrometers), magnetometers, microphones, proximity sensors, ambient light sensors, Global Positioning System (GPS) sensors, hall effect sensors and other magnetic sensors, physical keys (such as the key for letters, numbers, symbols and characters, which appear on a touch screen of the device, touch sensors (of the touch screen), including haptic sensors, headphone command sensors, and the like. The sensors 15a-15n are coordinated with the DSP 40, such that the DSP 40 receives signals from sensors 15a-15n of the electronic device 10.

The DSP 40 is configured to receive signals from one or more sensors 15a-15n, for example, contemporaneous in time, including at the same time (e.g., simultaneously). For example, inputs may be received from a microphone and from an accelerometer simultaneously, or from a proximity sensor and an ambient light sensor simultaneously. The DSP 40 recognizes each input independently and processes these inputs together, to generate a single discrete signal from the combination of those multiple sensors based on joint processing.

The DSP 40 processes those multiple sensor 15a-15n inputs based on a variety of algorithms, for example, but not limited to, machine learning algorithms, statistical algorithms, dynamic time warping algorithms, digital filtering, Fourier transformations, fuzzy logic and the like.

The DSP 40 also functions to process joint sensors 15a-15n by combining signals in a variety of ways, and including a set of conditions, such as, input from an accelerometer (input over three dimensional (3D) axis) and physical key pressure. The accelerometer input signals are, for example, processed to recognize angles of inclination of the device 10. The DSP 40 generates a pulse only in response to a specific key on the device 10 being touched or otherwise depressed, and angles of inclination are within a certain range.

The input for the DSP 40 is, for example, one or more continuous sensor inputs. The DSP 40 output is an individual digital signal. For example, the microphone input signal can be processed by an algorithm in the DSP 40 in order to recognize a user blowing on the microphone. After several stages of signal processing, the output signal is a square wave signal identifying the user's blowing toward or into the device 10.

The signal adapter 50 receives digital signals from the DSP 40 as an input, and extracts time events to be placed in a handler queue 60a for further processing. For example, from a pulse-like signal, the signal adapter 50 may extract a sequence of “ON” and “OFF” events, associated with specific timestamps. The signal adapter 50, is, for example, based on multiple thresholds.

The handler 60 is associated with a handler queue 60a and handler control logic 60b. The handler control logic 60b of the handler 60 extracts data from the queue 60a, for example, corresponding to events or groups of events, aggregates this data, looks for patterns of events, and notifies to the software application 90, should a group of events and/or the group of events as a pattern of events, as required by the software application 90 and provided to the control logic 60b by the software application 90 be detected, or otherwise determined. The handler control logic 60b typically recognizes the specific sensors 15a-15n from which the events were generated. For example, the handler control logic 60b receives a sequence of time events, can perform comparison and analysis functions with stored event groups based on patterns, such as correlations including matching (for example, matching to a predetermined threshold) of the event groups or patterns, and can then produce specific instructions as an output. The stored event groups are typically received in a request from an application 90 running on the device 10. The instructions may become notifications for a user-facing software, for the operating system 34, for a user interface, an application, and the like. The handler control logic 60b may also tune or modify patterns properties according to initialization parameters.

The handler control logic 60b is also suitable to be integrated into the electronic device 10 Operating System (OS) 34.

The profiling database 70 allows for the optimal performance of both the DSP 40 and the handler control logic 60b, in the device 10 in which they are running. The profiling database 70 is populated by collecting data from a set of source devices (802a-802n in FIG. 8), as detailed for FIG. 8 below, analyzing this data, and creating a tailored configuration file. The data collected from source devices 802a-802n includes, for example, device information (e.g., device name, manufacturer, model, brand), hardware information (e.g., CPU, memory, display, battery), software information (OS release, build number), sensor information (e.g., list of all sensors mounted on the device or connected with it, with corresponding name, vendor, nominal performances, features and the like), and the results of a set of interactive tests with the user. These interactive tests provide important data, as they aim to obtain actual performance of the device 10 and its sensors 15a-15n.

Examples of interactive tests include tests to compute: dynamics of the proximity sensor, dynamics of the ambient light sensor, accuracy of accelerometer sensor, behavior of sensors 15a-15n when the CPU 30 is idle, position of physical keys, and the like. During an interactive test, a user 11 could be asked to perform some gesture (e.g., move a hand in a particular way) or activity (e.g., walk or run), in order to collect sensor data during a particular context. This data is analyzed by a dedicated algorithm that elaborates and aggregates it in order to generate tailored configuration files for several sets of devices, such as device set 802a-802n. A device set may include, for example, all devices with the same model name, with the same manufacturer, with the same OS version, and the like.

The software application(s) 90 produces requests (i.e., event requests) for event(s) and/or at least one group of events, for example based on a pattern of events, as required by the software application 90, which are transmitted to and received by the handler control logic 60b. These requests, i.e., event requests, are, for example, stored, at least temporarily, in the control logic 60b and/or storage media associated with the control logic 60b. For example, the application 90 can issue requests (event requests) for the handler 60, e.g., handler control logic 60b, to recognize event(s), one or more event groups, and/or patterns (formed of events), as predefined, and required by the software application 90.

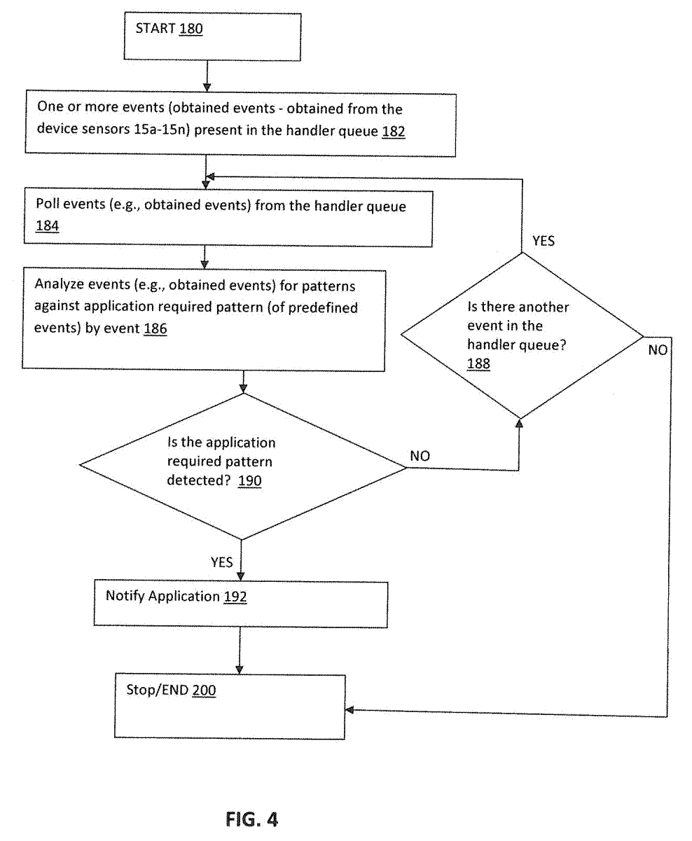

For example, the software application 90 required event(s), one or more event groups, and/or patterns (formed of events), or data associated therewith (which allows for analysis by the handler control logic 60b, such as that described for and shown in FIG. 4), are typically included in the request, sent by the software application 90 to the handler 60, e.g., handler control logic 60b. Alternately, the handler 60 and/or control logic 60b can “pull” the request (event request) from the software application 90.

The handler control logic 60b, as discussed herein, compares the event(s), one or more event groups, and/or patterns (formed of events) of the event request, with event(s), groups of events and/or patterns, as detected or otherwise obtained by the sensors 15a-15n and processed by the handler 60. Should there be a correlation (as determined, for example, by the handler control logic 60b and/or CPU 30 of the device 10) of the detected or otherwise obtained event(s), event groups, and/or patterns (of events), to one or more of the events, event groups and/or patterns of the event request of the software application 90, the handler 60 and/or handler control logic 60b transmits a signal, command, or other notification, for example, to the application 90 or another application, for notifying or otherwise informing the device 10 user of a condition, situation, or the like. For example, a correlation may include matches of the events in the event group to one or more of the event(s), event groups, and/or patterns in the event request, the match satisfying at least a predetermined threshold, The events and/or groups of events from which patterns, such as the application required patterns, may be determined by being machine learned in each application 90.

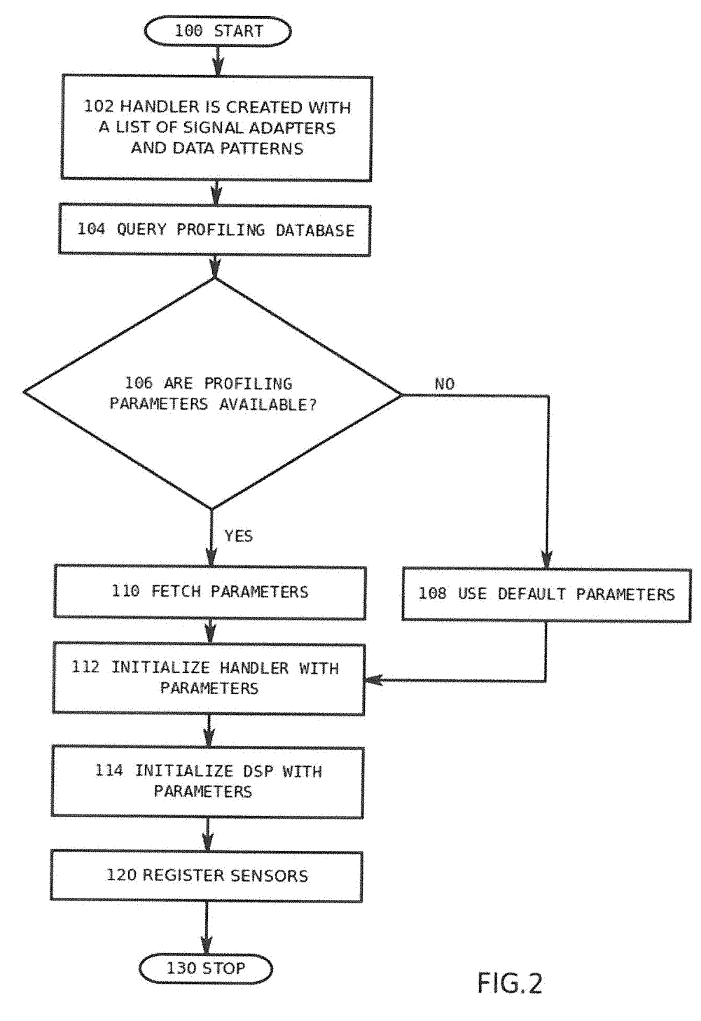

FIG. 2 is a flow diagram of the process (method) for the initialization of the present invention. Initially, at block 100, the software application(s) 90, as executing on the device 10, waits to receive a notification command from the handler 60, as the handler 60 has generated a the list of signal adapters, from which the handler queue 60a will be fed. The device profiling database 70, is queried by the handler 60 and the signal adapters 50, at block 104. At block 106, the database query 104 returns a set of optimization parameters for the device 10 and the sensors 15a-15n, which are going to be used, at block 110, where the parameters are fetched or otherwise obtained from the profiling database 70. Should the profiling database 70 be empty of parameters for a device 10 or a sensor 15a-15n, default values will be used for those parameters, at block 108. The resulting parameters will be used to finalize the initialization of the handler 60, at block 112 and to initialize the DSP 40, at block 114. If the parameters require an external component, for example, a library for natural-language speech recognition or a library for user context classification (walking, sitting, cycling, etc.) the component is initialized, at block 118. Additionally, the sensors 15a-15n which were used in the process are registered to the Operating System (OS) 34 of the device 10, in order to receive the sensor signal input, at block 120, and block 130 (where the process ends).

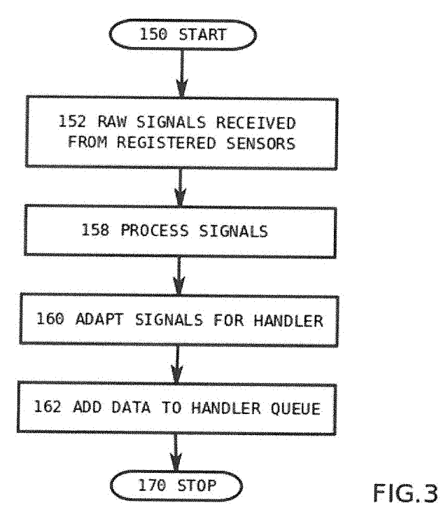

FIG. 3 is a flow diagram of the subprocess from the reception of sensor signals input to the handler queue 60a. Signals from one or more sensors 15a-15n are received, at block 150 (START), and block 152. The process moves from block 152, to block 158, the DSP 40 processes the incoming signals, generating a new signal 158. The signal adapter 50 extracts data from this signal at block 160, and adapts the signals for the handler 60. The process moves to block 162, where data is added to the handler queue 60a. Each piece of data added to the queue is also called an “element” or “event” of the queue 60a. The process moves to block 170, where it ends.

FIG. 4 is a flow diagram of the subprocess from the handler queue 60a to the notification signal and transmission to a software application 90. When at least one event (added by block 162 of FIG. 3) is in the handler queue 60a, at the START block 180, the process moves to block 182. The first event, also known as an obtained event (obtained from the sensors 15a-15n), is polled, at block 184, and passed to the handler 60. The handler 60, via the handler control logic 60b, processes the data, associated with or otherwise corresponding to the event, together with the previously received data, associated with or otherwise corresponding to one or more events (e.g., obtained events), and according to initialization parameters, and profiling database parameters, analyzes the events (e.g., obtained events), for example, for data patterns (or patterns), at block 186. The events (e.g., obtained events) being used in the analysis for the patterns are typically considered as a group of events. If the data pattern, for example, of events which define the pattern, as required by application 90, and provided to the control logic 60b, for example, upon the control logic 60b receiving a request (e.g., event request) from the application 90, is detected or otherwise found, at block 190, by the control logic 60b determining that the obtained events correlate to the pattern, the process moves to block 192. Since these is a correlation, between obtained event(s) and an application 90 pattern of defined events, which has been determined, for example, by the control logic 60b, a notification is issued, at block 192 to the software application 90, for example, by the handler 60. The process moves to block 200, where the process ends. The correlation is, typically predetermined and preprogrammed into the control logic 60b, and for example, may include event and/or pattern matching to at least a predetermined threshold.

Returning to block 190, should a pattern not be detected at block 190, and there is still at least one event (e.g., obtained event) in the handler queue 60a, the process moves to block 188. With at least one event (e.g., obtained event) in the handler queue 60a, the process moves to block 184, from where it resumes. Should the handler queue 60a lack events, the process moves from block 188, to block 200, where the process ends.

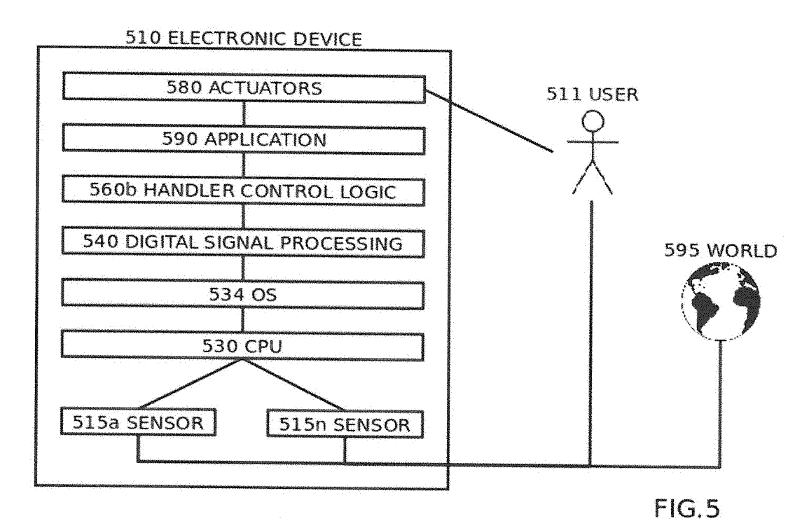

FIG. 5 to FIG. 8 are diagrams of exemplary systems on which embodiments of the present invention is performed. In these figures, elements with the same numbers in the “500s”, as those of FIGS. 1A and 1B, are the same as those described in FIGS. 1A and 1B above, and the descriptions are applicable here. Components which are not mentioned in FIGS. 1A and 1B, are discussed with their respective embodiment and corresponding figure.

In the embodiment of FIG. 5, all components of the present invention are on-board a single electronic device 510, associated with a user 511. The device 510 links to the network(s) 12 and destinations 14, as detailed for FIG. 1A above. The device 510 includes a DSP 540 and handler control logic 560b are layers above the operating system 534 and the CPU 530. The user 511 and the external world 595 stimulate, in this case, two sensors 515a 515b of the device 510. Handler control logic 560b notifies controls to software applications 590 that in turn control the actuators 580 of the electronic device 510.

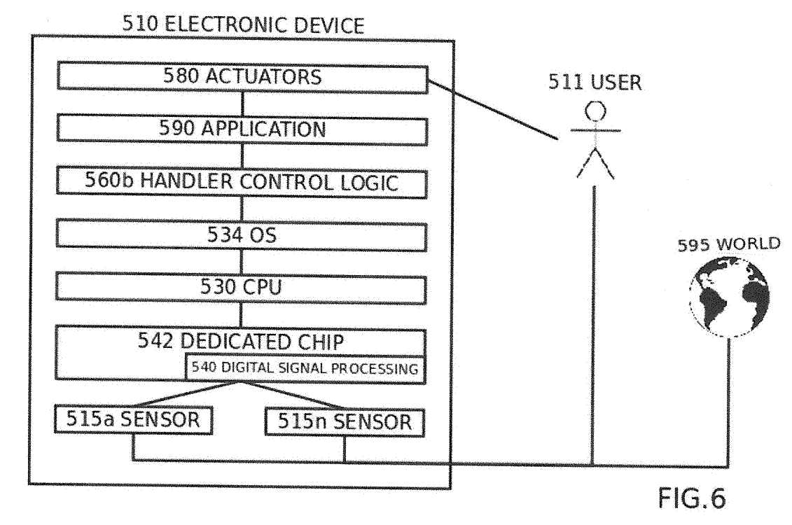

In the embodiment of FIG. 6, the DSP 540 is integrated as an IP (Intellectual Property) CORE 571 (an IP core is a reusable unit of logic, cell or chip layout design that is the intellectual property of an entity) into a dedicated chip 542, that is interposed between sensors 515a, 515b and the CPU 530. The dedicated chip 542 for signal processing improves time performance, relieves the CPU 530 of tasks, and reduces the overall device 10 power consumption.

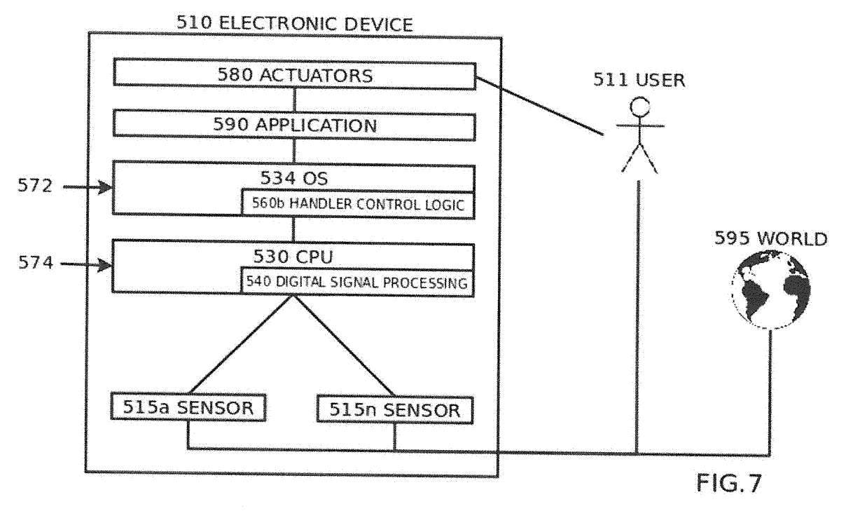

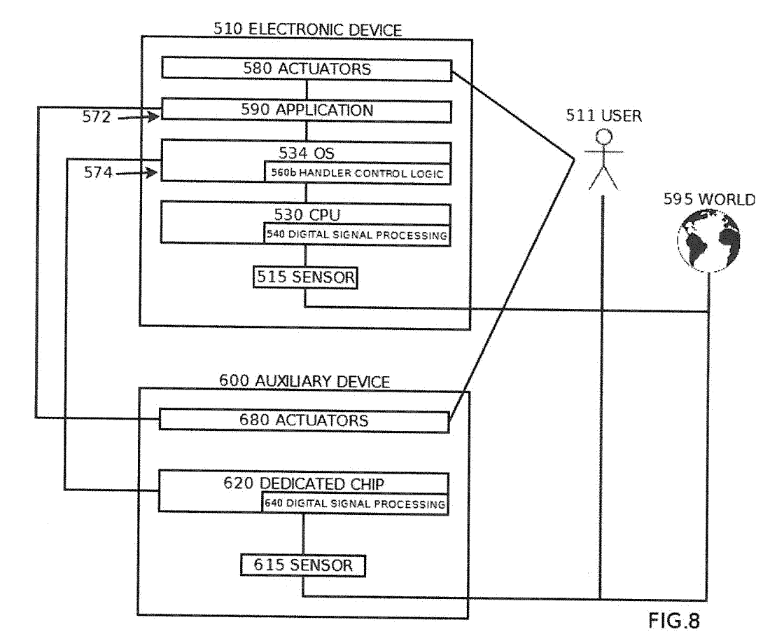

In the embodiment of FIG. 7, the DSP 540 is integrated as an IP CORE 572 into a dedicated chip with the CPU 530, and the handler control logic 560b is integrated into the operating system 534, as an IP core 574. The integration of handler control logic 560b into the OS 534 reduces latencies and prevents fragmentation issues (fragmentation).

In the embodiment in FIG. 8, together with the main electronic device 510, there is an auxiliary electronic device 600. Components of the auxiliary device 600 of FIG. 8, have the same numbers in the 600's, and are in accordance with the correspondingly numbered components as described above and shown in FIGS. 1A and 1B. The user 511 and the environment 595 stimulate a sensor 515 on the main device 510, and a sensor 615 on the auxiliary device 610. In this embodiment, the auxiliary device 600 is carried on a dedicated chip 620, integrated with the DSP 640. The auxiliary device 600 sends the processed signal to the main device 510. The handler control logic 560b on the main device 510 uses signals incoming from the local device CPU 530 (that in this embodiment has the DSP 540 integrated) and the auxiliary device 600, and provides notifications to the software application 590. The software application 90 in turn controls actuators 580, 680 both on the main device 510 and in the auxiliary device 600.

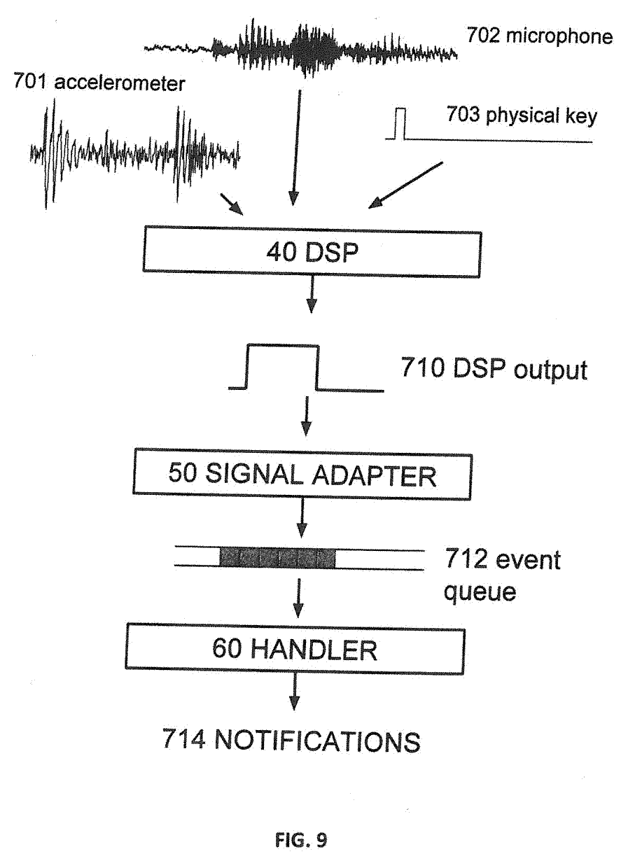

FIG. 9 to FIG. 13 are diagrams illustrating examples of full stack signal processing, from input, as received from the sensors 15a-15n, to application 90 notification, by the handler 60. This signal processing is performed by the DSP 40, which processes the raw input signals and correlates the input signals coming from different sources (sensors 15a-15n), as better explained in example applications FIGS. 16A-1, 16A-2, 16B-1, 16B-2, 16C, 17A, 17B, 17C, 18 and 19A-1, 19A-2 and 19B.

FIG. 9 is a diagram of the full stack (an application/program which uses multiple libraries) in an example operation of the present invention. This diagram is a visual overview of the entire operation sequence, from raw input received from sensors, to application notification; this diagram shows the flow from the input signal up to the application notification. In this example, the DSP 40 receives as input, three analog signals from sensors 15a-15n, e.g., an accelerometer input signal 701, a microphone input signal 702, and a physical key input signal 703. The DSP 40 processes the input from the accelerometer 701, microphone 702 and physical key 703, by combining and converting these received input signals and generating a single output signal 710. The signal 710 is further processed by the signal adapter 50, that extracts features from the input signal 710, and creates a queue (queue event) 60a. Each element, also called “event”, of the queue 60a contains the name of the features extracted and other information, for example, but not limited to, the timestamp of the feature (disclosed in further detail below). The queue 60a, also called “event queue”, is passed to the handler 60, that associates each of the events into a group, based on the pattern of the events, compares the group of events (e.g., pattern) with the event request (e.g., a pattern required by the application 90), and, transmits a notification 714 when the group of events correlates to the application 90 required pattern, in particular, the defined events of an event group that make up the application 90 required pattern. The correlation is typically predefined, so as to be a correlation should a minimum threshold be met. The correlation can also include matching to at least a predetermined threshold.

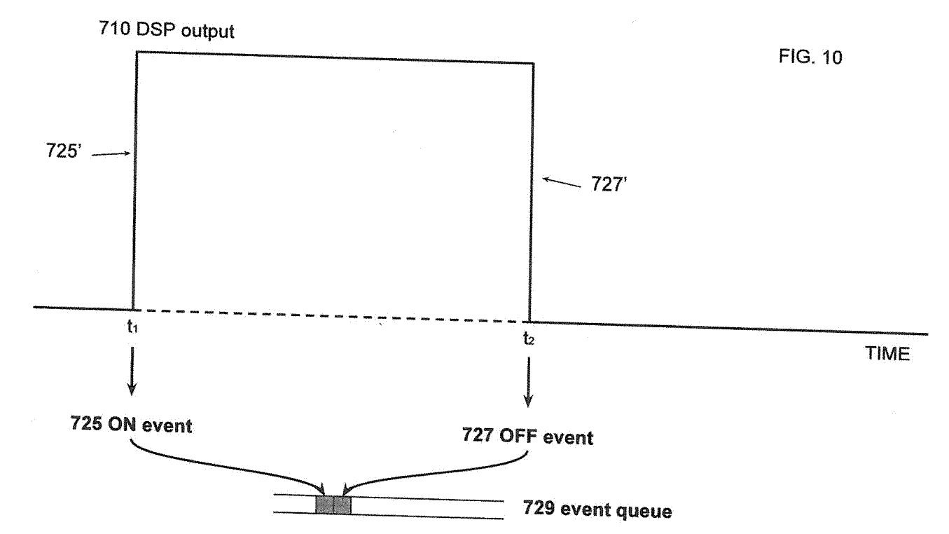

FIG. 10 is a diagram of the signal adapter 50 conversion from the DSP output 710 to an events queue 729, located, for example, in the Operating System 534. In this example operation, the signal adapter 50 receives the digital signal(s) from the DSP 40 as an input, and extracts time events to be placed in a queue 60a for further processing. The signal adapter 50 extracts a sequence of “ON” and “OFF” events, associated with specific timestamps, from a pulse-like signal, resulting from the detection of the raising edge and falling edge, respectively, of the DSP output 710.

The DSP output 710 (shown, for example, as a signal) is processed by the signal adapter 50. The signal adapter 50 is, for example, programmed, to detect two features, including, for example, a rising edge 725′ of the signal (called ON event 725), and a falling edge 727′ of the signal (called OFF event 727). In this diagram the DSP output signal 710 has a rising edge 725′ at time t₁, that is detected by the signal adapter 50 as the “ON event” 725, and a falling edge 727′ at time t₂ (a time after time t₁), that is detected by the signal adapter 50 as the “OFF event” 727. Both events are pushed by the signal adapter 50 into the output queue 729.

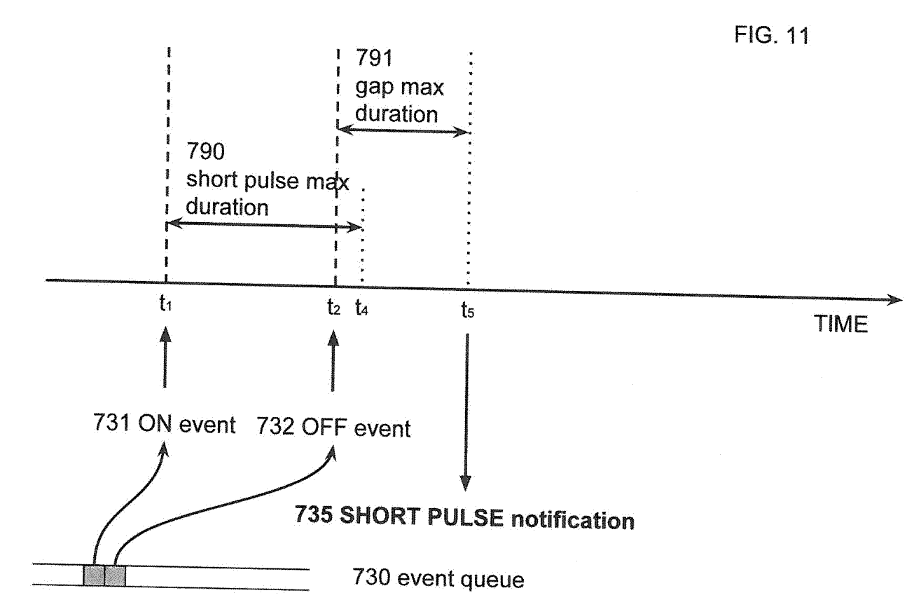

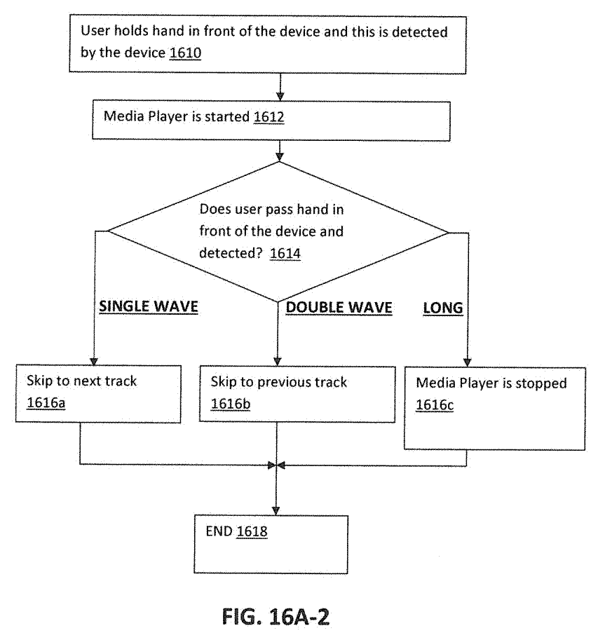

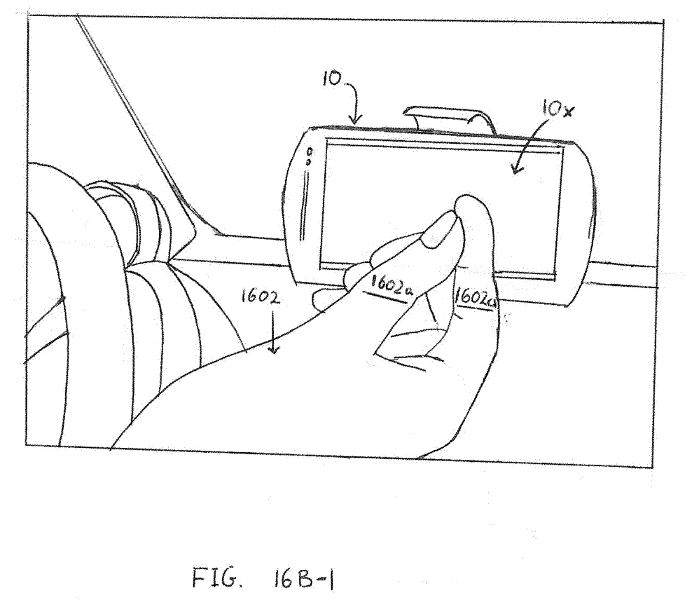

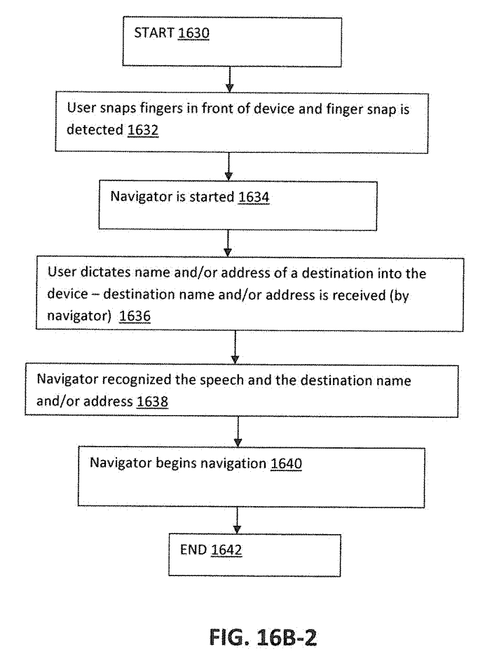

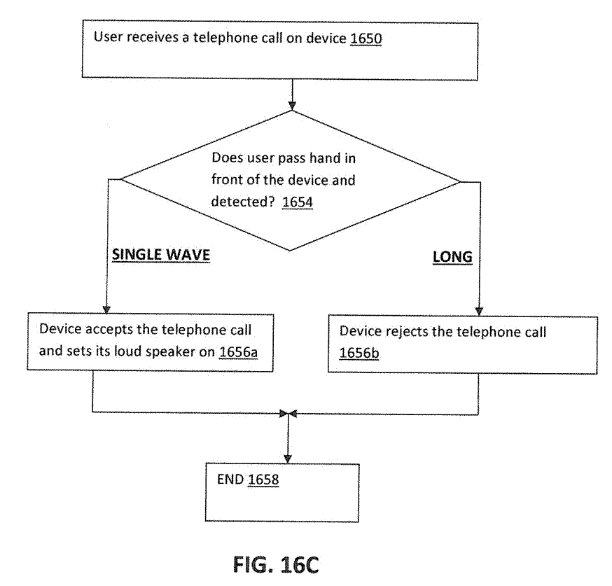

FIG. 11 is a diagram of the handler 50 recognizing a short pulse pattern. The short pulse pattern allows recognition of fast or impulsive user interactions, such as a finger snap (FIG. 16B-1) or a hand moving (FIG. 16A-1) fast above or otherwise, for example, in front of the device 10 (e.g., in front of the touch screen 10x of the device 10). In this example, the application 90 has requested the handler 60 to recognize the event group corresponding to the short pulse pattern. In this example, the event queue 730 has two elements: an ON event 731 at time t₁ and an OFF event 732 at time t₂ (a time after time t₁). The time difference between the OFF and ON events, expressed as (t₂−t₁) or Δt₂₋₁, is compared against a threshold 790 (short pulse max duration), for example 1000 milliseconds (ms). In this example, the time difference Δt₂₋₁ is shorter than the threshold 790. In this case, if any other events arrive within another time threshold 791 (gap max duration), for example 500 ms, a short pulse notification 735 is issued by the handler 60 (and is transmitted to the software application 90). Such a notification causes the possibility for the software application 90 to take an action, for example actuate an actuator, display information on the screen, play a sound, or communicate with another device or a server.

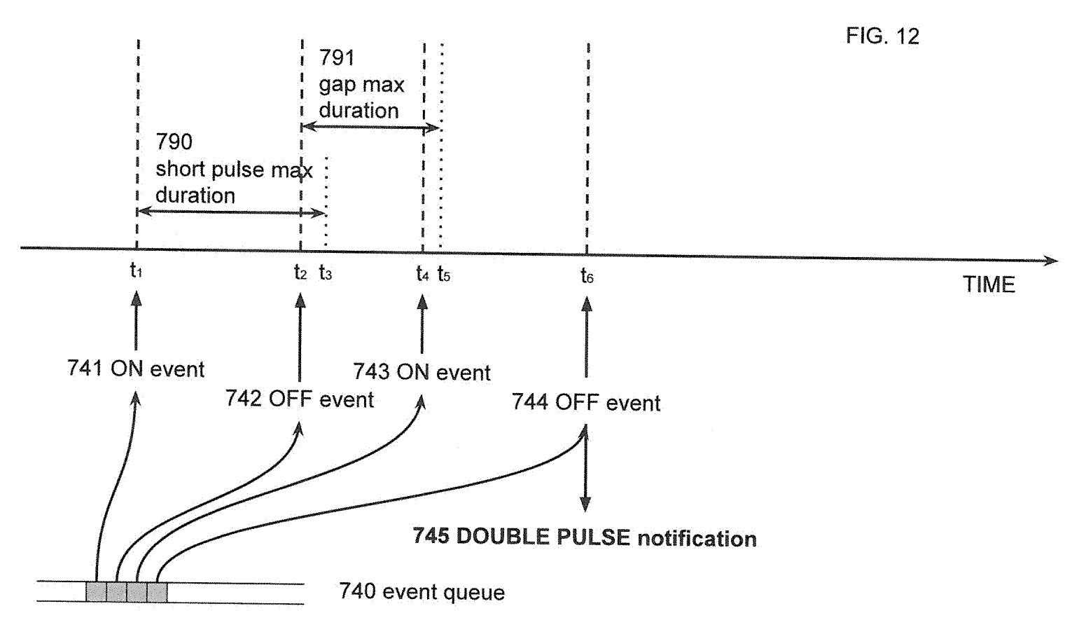

FIG. 12 is a diagram of a handler 60 recognizing the double pulse pattern of FIG. 11. In this example, the application 90 has requested the handler 60 recognize the event group corresponding to the double pulse pattern. In this example, the event queue 740 (of the handler 60) has four elements: 1) an ON event 741 at time t₁, 2) an OFF event 742 at time t₂, 3) an ON event 743 at time t4, and 4) an OFF event 744 at time t₆. The time difference between the first OFF 742 and ON 741 events, is (t₂−t₁) or Δt₂₋₁. This time difference is compared against a threshold 790 (short pulse max duration), for example 1000 ms. In this example the time difference is shorter than the threshold 790. In this case, a new ON event 743 arrives within another time threshold 791 (gap max duration), for example 500 ms, and a double pulse notification is issued 745 to the handler when the following OFF event 744 arrives at time t₆.

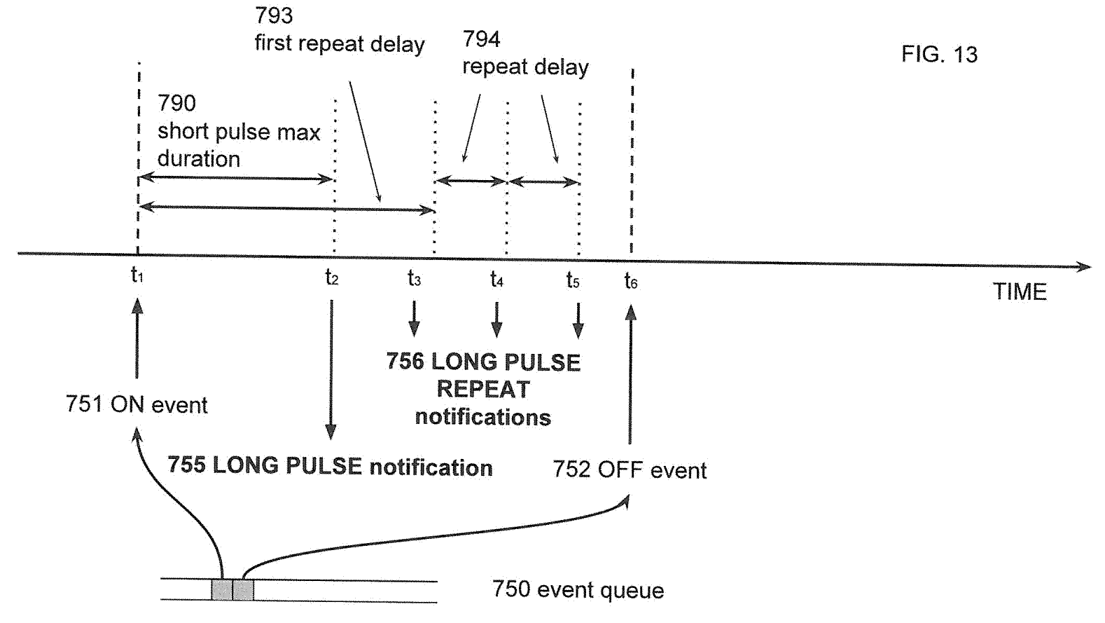

FIG. 13 is a diagram of a handler 60 recognizing a long pulse pattern with repeated intra-pulse notifications. In this example, the application 90 has requested the handler 60 to recognize the event group corresponding to the long pulse pattern with intra-pulse notifications. In this example, the event queue 750 has two elements: 1) an ON event 751 at time t₁; and, 2) an OFF event 752 at time t₆. The time difference between the OFF and ON events, is (t6−t1) or Δt6−1, is compared against a threshold 790 (short pulse max duration), for example 1000 ms (milliseconds). In this example the time difference Δt₆₋₁ is longer than the threshold 790. In this case, long pulse notification 755 is issued at time t₂ to the handler 60. Moreover, since intra-pulse notifications were required by the application 90, other notifications, such as long pulse notification 756 are issued (and transmitted to the application 90). After a time threshold 793 (a first repeat delay) since the ON event 751, for example 1200 ms, the first long pulse repeat notification 756 is issued to the application 90. After another time threshold 794, for example, 200 ms, other pulse repeat notifications 756 are issued until superseded by an OFF event 752. All thresholds and other parameters could be assigned by the requesting application to the handler. If not assigned, the threshold are set to a default value, eventually fetched by the profiling database 70.

Other patterns can be recognized as combination of the above patterns. For example, it is possible to recognize a short-long pattern, that is, a short pulse followed by a long pulse; or a long-short pattern, that is, a long pulse followed by a short pattern; or also, a long-long pattern, or also longer chains as short-short-short (triple pulse notification), short-short-long and the like. For each long pattern, it is optionally possible to generate repeated intra-pulse notifications as described for FIG. 13.

The present invention may also include other patterns in addition to the patterns described above. These other patterns would be processed in accordance with the patterns detailed above.

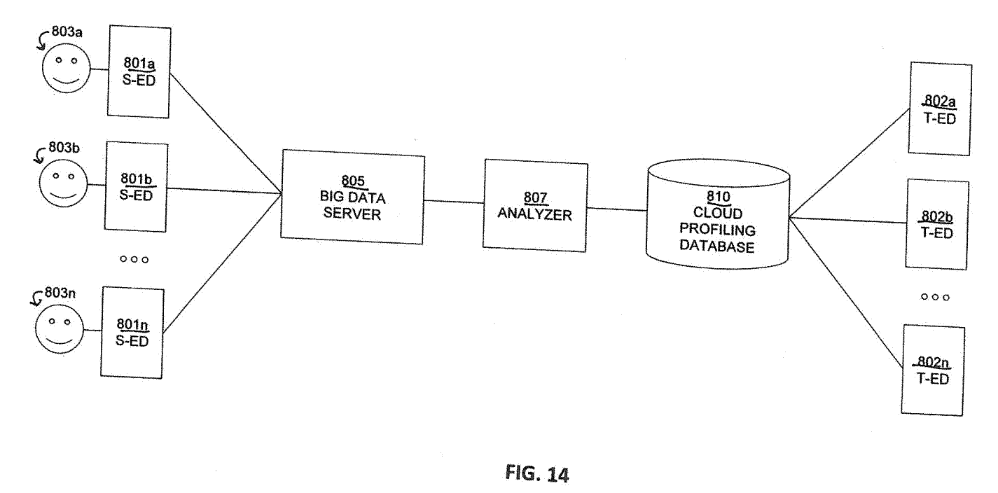

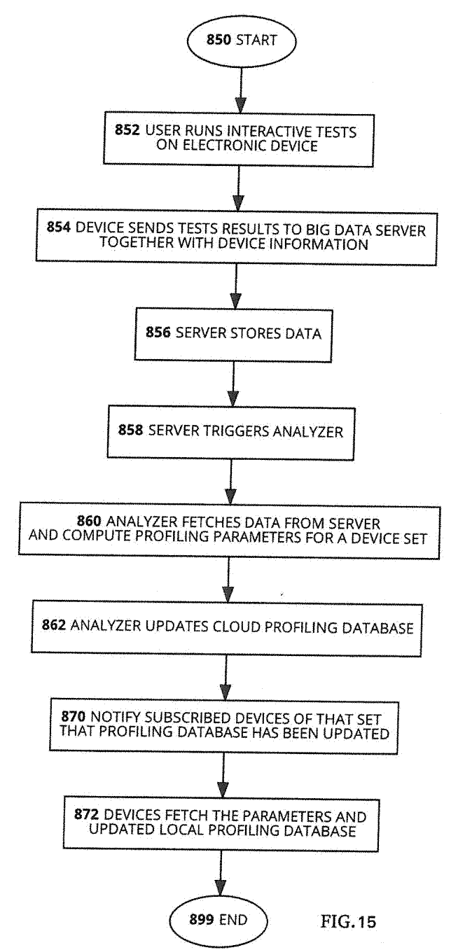

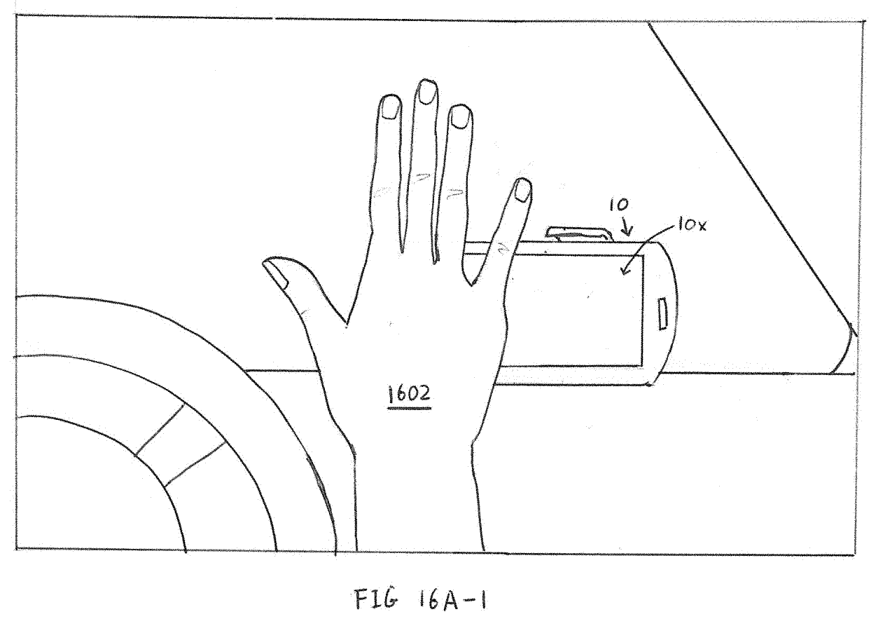

FIG. 14 and FIG. 15 illustrate the profiling database 70. The profiling database 70 contains parameters that are used to adapt the DSP algorithms and handler control logic according to the specific device 10, in order to improve algorithm accuracy and reliability (reduce false positive and false negative) and reduce power consumption. Each device 10 has different characteristics and includes different kinds of sensors and actuators. The profiling database 70 allows for knowing exactly the performances of device 10 components, for example sensor dynamics, sensor behavior while the screen of the device 10 is off and/or the CPU 30 is idle, power consumption details in several context of use (e.g., the power consumption when the screen is completely white or completely black). This kind of data is generally not available using system calls (e.g., requiring sensor information to the Operating System 34); some other time, the information is available but incorrect. A specific device 10, such as one of the devices mentioned above, con be identified by its device manufacturer name (e.g. “Samsung”), model name (e.g. “S5”), Operating System name (e.g. “Android”), Operating System version (e.g. “5.0” or “API 20”), OS build number (e.g. “MMB29O”), CPU model, or other physical and software identifiers, and by any combination of thereof.

In order to compute parameters of the profiling database 70, a number of tests are typically employed. The parameters, for example, are computed using statistical operations over the test results, as, for example, computing mean, median, mode, standard deviation, variance and the like. For example, accelerometer performances parameters need hundreds of tests. To collect test results and compute parameters, a client/server architecture is used: users run tests on their devices (clients) and the results are sent to a remote server. When the server collects enough test results, parameters can be computed and the profiling database can be populated. These parameters in the profiling database 70 are then sent to or fetched (obtained) by client devices, as described below. When the client device obtains the parameters, automatically use them to adapt DSP algorithms and handler control logic. However, users may continue to run tests and generate test results, increasing the number of test results that are available and then improving the accuracy of parameters in the profiling database 70.

The DSP algorithms and handler control logic may also work without using the parameters obtained by the profiling database 70, by using default values.

FIG. 14 is a system diagram for the population and utilization of the profiling database 70. The profiling database 70 is populated by collecting data from a set of source devices 801a-801n, when interactive tests with the respective user 803a-803n, are running. The devices 801a-801n send their data to a remote “big data” server 805. The remote server 805 stores a large amount of data (e.g., hundreds of gigabytes) from a large number of devices (e.g., 10,000+). The analyzer 807 aggregates the data in order to generate tailored configuration files for several sets of devices. These configuration files are stored in a cloud profiling database 810, that stores parameters for the profiling database 70 of all device sets. The target devices 802a-802n fetch the parameters from the cloud profiling database 810. The parameters are then used for tuning the DSP algorithms and handler control logic 60b, in order to improve accuracy and reduce power consumption, as detailed above.

FIG. 15 is a flow diagram of the process (method) of system diagram in FIG. 14. Initially, at the START block 850, the process begins, with the device 801a-801n powered ON and an interactive test suite is available on the device. Next, at block 852, the requisite user 803a-803n runs the interactive tests on the source device 801a-801n (each of these devices representative of devices 10 and 510). At block 854, tests results together with device information, including, for example, device name, device manufacturer, device model, CPU, memory, display type, battery type, OS release, OS build number, the list of all sensors mounted on the device or connected with it, with corresponding name, vendor, nominal performances, features and the like, are sent to the remote “big data” server 805. At block 856, the server 805 stores incoming data, and at block 858 triggers the analyzer 807. At block 860, the analyzer 807 fetches the new data together with part of the other existing data that it may need, and compute profiling parameters for the device sets of the source devices 801a-801n. At block 862 the analyzer 807 updates the cloud profiling database 810. In turn, at block 870, the database 810 notifies to subscribed devices 802a-802n that are part of the modified device set, that a new profiling database is available. At block 872, the devices 802a-802n fetch the new parameter from cloud database 810 and update the local profiling database 70. The process then moves to block 899, where it ends.

Example alternatives to the process of the flow diagram in FIG. 15, as detailed above, are now described. For example, the interactive tests 852 may be launched automatically when a particular event occurs, e.g., an application is launched for the first time.

In another alternative, for example, the server 805 does not directly trigger the analyzer 807, as shown in block 858. Rather, instead, the analyzer 806 runs periodically (e.g. every 15 minutes), independently by virtue of new data arriving. This reduces the computation work, when large amounts of data, e.g., gigabytes, arrive from the source devices 801a-801n.

As another example of an alternative, the cloud profiling database 810 cannot notify the target devices 802a-802n. Instead, these devices periodically check (“pull” from) the cloud database 810 for updates (for example, at intervals, such as every 15 minutes, once a day, or other set interval). This may be the only option for the target device to update its parameters if there is not a server providing publisher services (e.g., “Google® Cloud Messaging” or “Apple® Push Notification Service”) in the network between devices 802a-802n and the cloud server 810. In fact, these publisher services are required to “push” notifications from the server to the device.

FIGS. 16A-1, 16A-2, 16B-1, 16B-2, 16C, 17A, 17B, 17C, 18 and 19A-1, 19A-2 and 19B are example applications of embodiments of the present invention.

### Example 1—In-Vehicle Operation, Hand and Voice Commands

Attention is directed to FIGS. 16A-1, 16A-2, 16B-1, 16B-2 and 16C, which are flow diagrams of the process (method) of an automotive application or service. These automotive applications are shown in an in-vehicle setting, typically while driving.

The application (or service) must be used safely while driving. Accordingly, the screen (touch screen or display) of the device 10 cannot be used, as it would distract the driver. Moreover, use of the device in this manner may not be legal in various localities.

The application (or service) running on the device 10, includes, for example, a media player, a navigator and a phone call manager. The application uses a handler 60 with a signal adapter 50 to recognize a finger snap, an adapter for object motion detection, and an adapter for speech recognition.

As shown in FIG. 16A-1, the device 10 is in a motor vehicle. For example, the touch screen 10x of the device 10 faces the user. The device 10 is, for example, a smart phone. The object motion detection adapter (e.g., a sensor) of the device 10 is able to recognize a hand 1602, for example, of the driver, but could also be a passenger, moving in front of the device 10, using, for example, the front facing proximity sensor of the device 10, that, is, for example, an infrared sensor. If the proximity sensor is not available, or if according to the profiling database 70 the sensor performance is low (e.g., the sensor is not able to recognize occlusion time shorter than 200 ms), the system of the device 10 automatically falls back to the ambient light sensor to recognize the hand. The ambient light sensor is, for example, a default, as programmed into the CPU 30 of the device 10. In another implementation, the proximity sensor and ambient light sensor may be used together in order to improve the accuracy of hand detection and also to determine hand movement direction.

The software application or service is designed to work, for example, as shown in FIG. 16A-2. Initially, at block 1610, the user holds his hand 1602 in front of the device 10 (e.g., in front of the touch screen 10x of the device 10), which is detected by the system of the device 10. Once detected by the device 10, the system of the device 10 starts the media player, at block 1612. When media player is started, waving a hand once in front of the device is detected at block 1614.

From block 1614, for example, the hand wave serves as a short pulse notification 735, and is received by object motion signal adapter. This detected single wave causes the media player to switch to the next track, at block 1616a. Alternately, from block 1614, waving a hand 1602 twice, detected as such at block 1616b, is, for example, a double pulse notification 745, and causes the media player to return to the previous track. As another alternate, from block 1614, holding the hand 1602 again in front of the device 10, as detected by the device 10, at block 1616c, results, for example, in a long pulse notification 756, which causes the media player to stop. From blocks 1616a, 1616b and 1616c, with the desired action taken, the process ends at block 1618.

In FIG. 16B-1 the user, for example, the driver or passenger, snaps his fingers 1602a, or her hand 1602 in front of the device 10 (e.g., in front of the touch screen 10x of the device 10), and the process of FIG. 16B-2 starts, at the START block 1630. The device is, for example, a smart phone. The finger snap of the fingers 1602a by the user is detected by the device 10, at block 1632, and the navigation functionality of the device 10 is launched (started), at block 1634. If the user speaks above the required noise level, and says the name of a destination, as detected by the device at block 1636, for example, an address, The navigator (navigation functionality) recognizes the speech, sets the trip destination, at block 1638, and begins navigation, at block 1640. With the navigation complete, the process moves to block 1642, where it ends.

As shown in FIG. 16C, at any moment, should a call be received on the device 10, e.g., a smart phone, as detected by the device at block 1652, the user waves his hand once in front of the device 10 (e.g., in front of the touch screen 10x of the device 10), as detected by the device 10, at block 1654. Should the device detect a single wave, e.g., short pulse, the device 10 accepts the call, at block 1656a. Alternately, should the user hold her hand in front of the device 10 at a predetermined distance, for example, at two inches or 5.1 centimeters (approximately), as detected by the device 10, the call is rejected at block 1656b. From blocks 1656a and 1656b, the process moves to block 1658, where it ends.

### Example 2—In-Vehicle Operations, Touch Commands

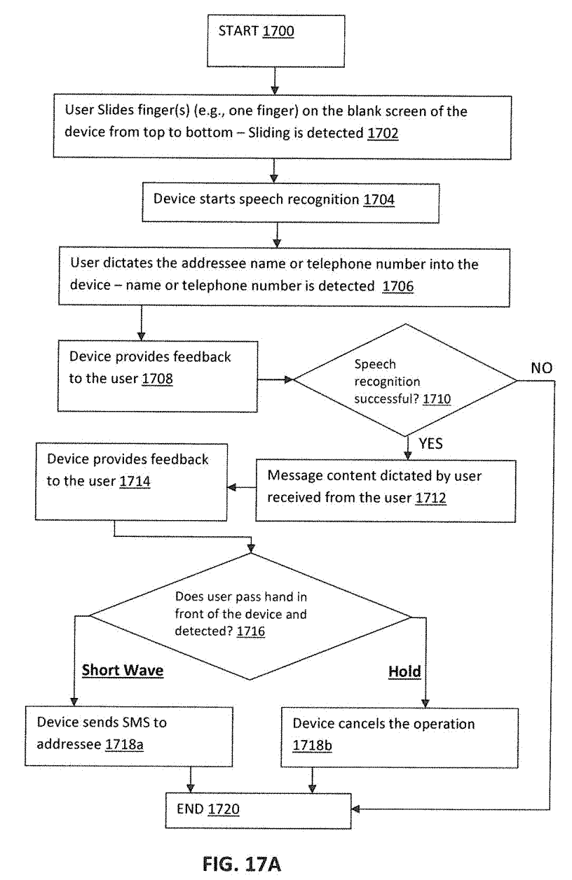

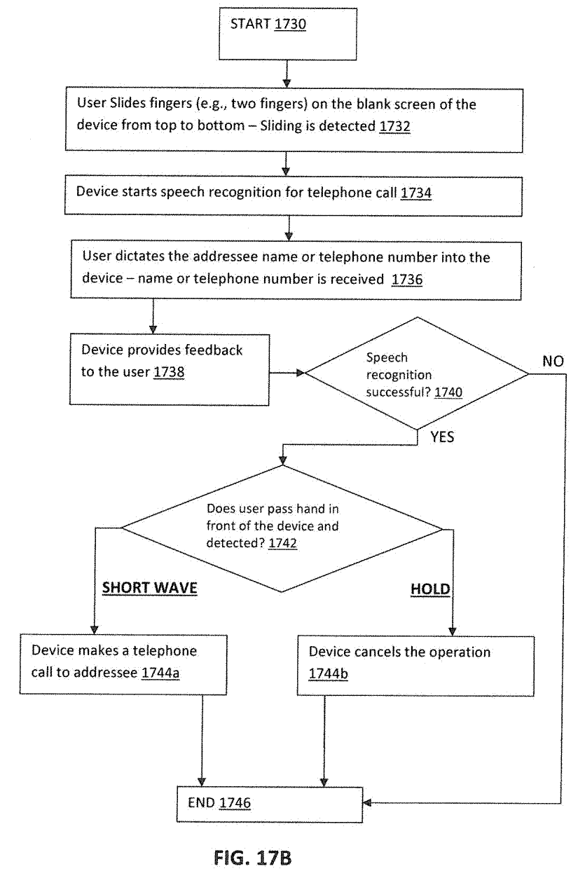

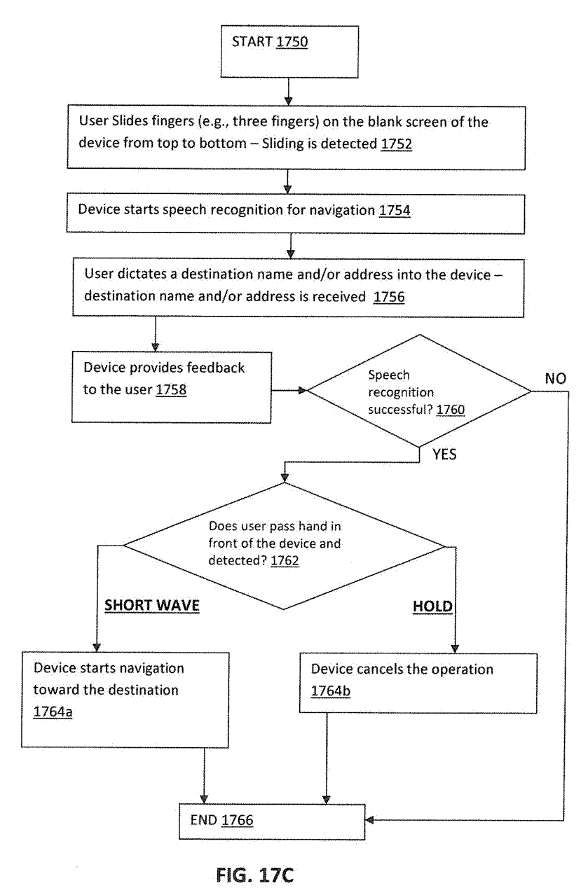

FIGS. 17A-17C are flow diagrams of the process (method) of another automotive application or service. In this automotive application (or service), a signal adapter 50 for touch screen 10x (FIG. 16A-1) gestures could be used to recognize driver commands, without the needs of distracting the driver's view of the street.

In FIG. 17A, initially, at the START block 1700, the screen (touch screen or display) 10x of the device 10 (e.g., FIG. 16A-1), e.g., a smart phone, is completely black to avoid distraction and to save energy. The user slides his finger or fingers on the screen to activate the device 10, to run commands, at block 1702. The contact point between screen and finger could be colored for feedback. Other sounds and voice feedback may be used in this application for feedback purposes. With the sliding of the finger(s) detected by the device 10, as the finger(s), for example move on the touch screen 10x, from top to bottom, the device 10 starts addressee name or number recognition, at block 1704. The device 10 receives the addressee name or number, as input (e.g., dictated) by voice by the user, at block 1706. The device 10 provides feedback to the user about the result of speech recognition, at block 1708. The process moves to block 1710, where it is determined whether the speech recognition is successful.

If the speech recognition is not successful at block 1710, the process moves to block 1720, where it ends. If speech recognition is successful, at block 1710, the process moves to block 1712, where the device 10 starts again the speech recognition for message content and the user dictates the message, which the device 10 receives. Moving to block 1714, the device 10, provides feedback to the user about the result of speech recognition. At this point, the user may confirm the message receipt in the device, at block 1716.

At block 1716, a single hand wave in front of the device 10, as detected by the device 10, is a short pulse, and causes the device 10 to send an SMS message to the addressee (recipient), at block 1718a. Alternately, at block 1716, should the device 10 select a hand being held in front of the device 10, a predetermined distance, for example, at two inches, as detected by the device 10, and/or for a predetermined time period, the device 10 cancels the operation, at block 1718b. With the operations of blocks 1718a and 1718b complete, the process moves to block 1720, where it ends.

In FIG. 17B, at the START block 1730, the screen (touch screen or display) of the device 10, e.g., a smart phone, is completely black to avoid distraction and to save energy. The user slides his finger or fingers on the screen to activate the device 10, to run commands, at block 1732. The contact point between screen and finger could be colored for feedback. Other sounds and voice feedback may be used in this application for feedback purposes. With the sliding of the finger(s) detected by the device 10, as the finger(s), for example, move on the touch screen, from top to bottom, the device 10 starts addressee name or number recognition for telephone calls, at block 1734. For example, at block 1734, the user speaks the name of a person in the address book, or a phone number, into the device 10.

The device 10 receives the addressee name or number, as input by voice from the user, at block 1736. The device 10 provides feedback to the user about the result of speech recognition, at block 1738. The process moves to block 1740, where it is determined whether the speech recognition is successful.

If the speech recognition is not successful at block 1740, the process moves to block 1746, where it ends. If the speech recognition is successful, at block 1740, the process moves to block 1742, where the device 10 detects whether the user has passed her hand in front of the device 10.

At block 1742, a single hand wave in front of the device 10, as detected by the device 10, is a short pulse, and causes the device 10 to make and process the phone call to the intended recipient, at block 1744a. However, alternately, at block 1742, should the device select a hand being held in front of the device 10, a predetermined distance, for example, at two inches (approximately), as detected by the device 10, and/or for a predetermined time period, the device 10 cancels the operation, i.e., the telephone call, at block 1744b. With the operations of blocks 1744a and 1744b complete, the process moves to block 1746, where it ends.

In FIG. 17C, at the START block 1750, the screen (touch screen or display) 10x of the device 10, e.g., a smart phone, is completely black to avoid distraction and to save energy. The user slides his finger or fingers on the screen to activate the device 10, to run commands, at block 1752.

The contact point between screen and finger could be colored for feedback. Other sounds and voice feedback may be used in this application for feedback purposes. With the sliding of the finger(s) detected by the device 10, as the finger(s), for example, move on the touch screen, from top to bottom, the device 10 is activated to receive a spoken navigational query, such as addresses, street names, building names, place and site names, and the like, at block 1754.

The device 10 receives the navigational query, as input by voice by the user, at block 1756. The device 10 provides feedback to the user, about the result of the navigational query, providing a map or routing, text or voice, at block 1758. The process moves to block 1760, where it is determined whether the speech recognition is successful.

If the speech recognition is not successful at block 1760, the process moves to block 1766, where it ends. If speech recognition is successful, at block 1760, the process moves to block 1762, where the device 10 detects whether the user has passed her hand in front of the device 10.

At block 1762, a single hand wave in front of the device 10, as detected by the device 10, is a short pulse, and causes the device 10 to make and process the navigation query, as either a map or voice commands routing the user to her destination, at block 1764a. Alternately, at block 1762, should the device 10 select a hand being held in front of the device, a predetermined distance, for example, at two inches (approximately), as detected by the device 10, and/or for a predetermined time period, the device 10 cancels the operation, i.e., the processing of the navigational query, at block 1764b. With the operations of blocks 1764a and 1764b complete, the process moves to block 1766, where it ends.

In the above automotive applications, to enhance safety, the application may block the use of some or all other applications in the device 10, e.g., messaging applications. Moreover, the application may limit the duration of the phone calls, for example to 30 seconds, to avoid dangerous driving behaviors and habits.

### Example 3-Hands Free Operation, Cooking

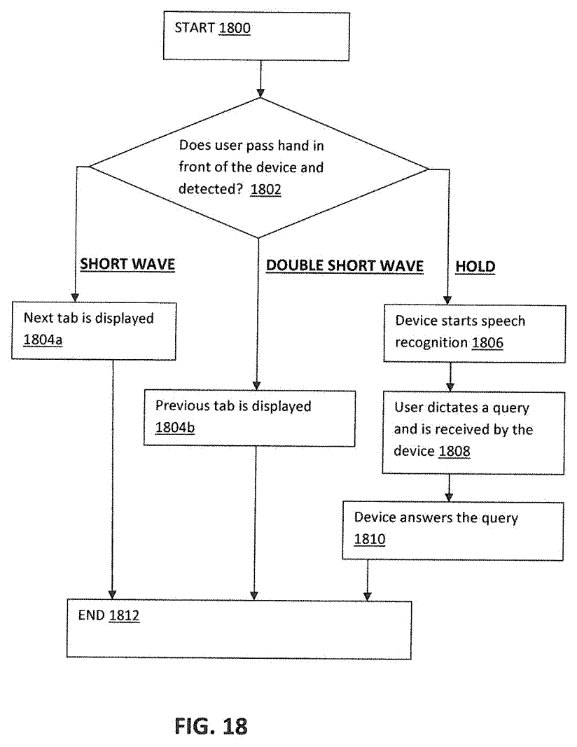

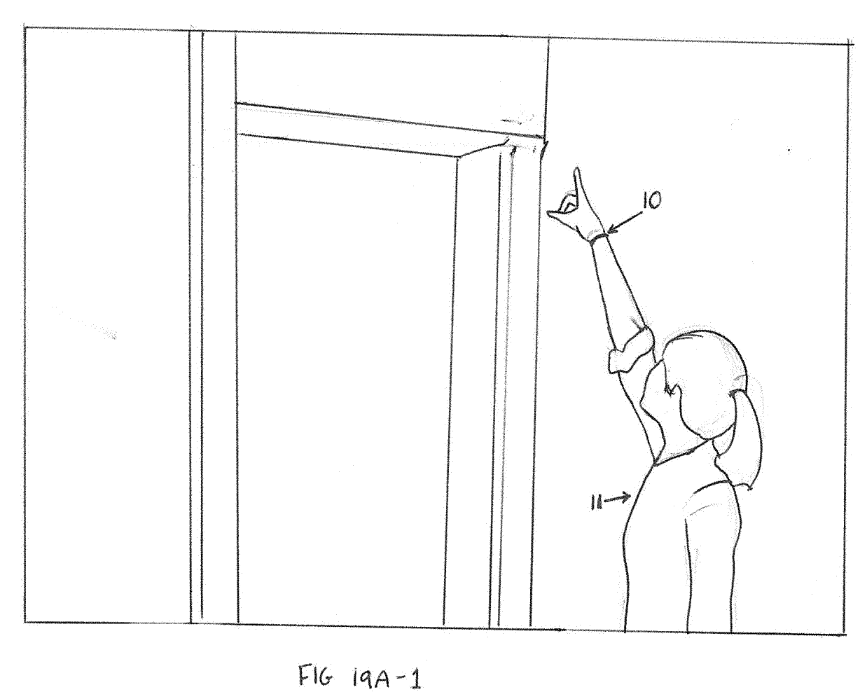

FIG. 18 is a flow diagram of the process (method) of an application for cooking. In this operation, the user typically keeps his hands free of the device 10, as they are either occupied with the cooking tasks, and in order to not dirty the device, as possible damage it, from wetness, oils, and other substances.

The application opens on the device at the START block 1800. With the application open, the user waves a hand once over the device 10, e.g., smart phone, and whether this wave is detected by the device 10, is determined at block 1802.

At block 1802, should the hand wave be detected as a single short wave, the process moves to block 1804a, where a further tab, which, for example, lists a step, ingredient, or combination thereof, is shown. Alternately, at block 1802, should the hand wave be detected as a double short wave, the process moves to block 1804b, where the previous tab is displayed. When the desired operations of blocks 1804a and 1804b are complete, the process moves to block 1812, where the process ends.

As a third alternate at block 1802, should the user hold his hand in front of the device, as detected by the device 10, as at a predetermined distance from the device 10 and/or for a predetermined time, the process moves to block 1806, where the device 10 starts speech recognition. The user then speaks or otherwise dictates a query to the device 10 for the application, at block 1808. The input query is, for example, for ingredients, cooking times, and the like. The process moves to block 1810, where the device 10 provides answers for the query, and, for example displays the answers, and may also present the answers by voice, sounds, or the like, in addition to the text (e.g., the tab). The process then moves to block 1812, where it ends.

In the devices 10 of Examples 1-3, several sensor adapters for different devices or variations on the gestures, hand movements and the like use may be used. For example, replacing the hand waving over the phone with a gesture on an auxiliary device, such as a wearable band, is also permissible.

### Example 4—Pointing Operations

FIGS. 19A-1, 19A-2 and 19B show a process (method) of an application for maintenance and inspection. For example, an inspector or person needs to check a list of items in a controlled environment, for example, an archeological site. Items could be, for example, walls, door frames, ancient remains, and the like. Device 10 is, for example, a wearable, such as a smart band (wristband), smart watch or other wrist-worn computerized device, as depicted in FIGS. 19A-1 and 19A-2, and worn by a user 11.

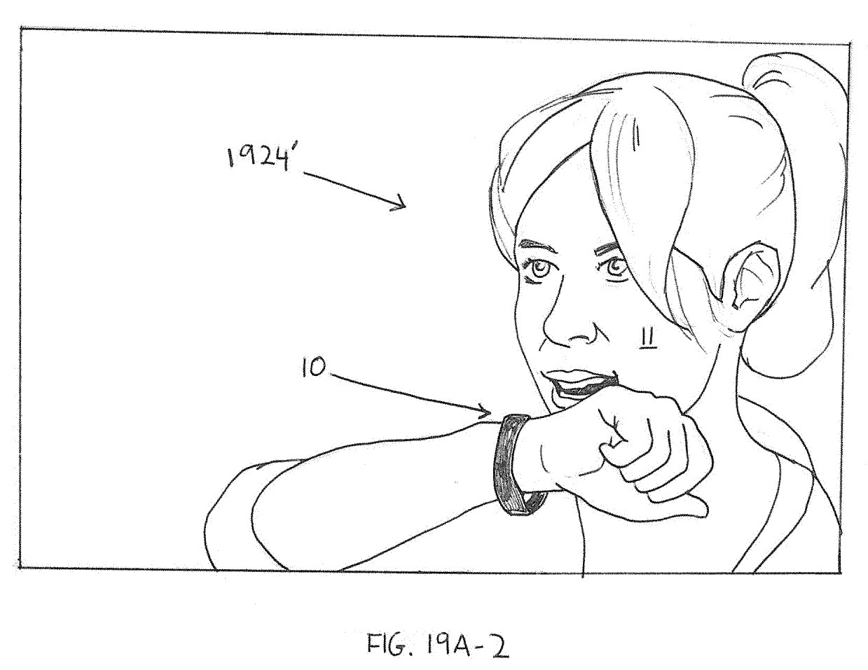

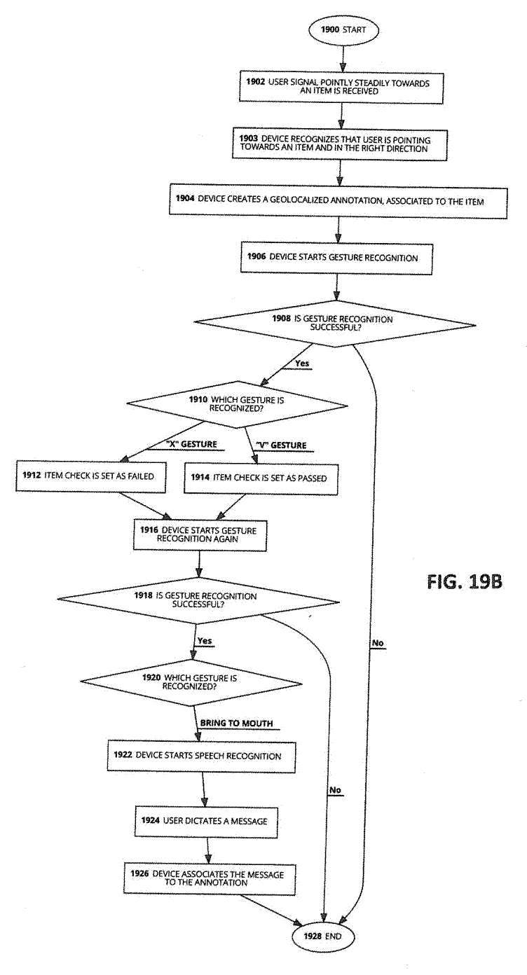

Attention is also directed to the flow diagram for the process, as shown in FIG. 19B. At the START block 1900, the application knows the position and orientation of all items in the environment. The user 11 at block 1902 points steadily towards an item in the list, as shown also in FIG. 19A-1. With the system detecting this pointing of the wearable 10. At block 1903, the system (of the device 10, e.g., the architecture 20) recognizes that user 11 is pointing towards the item, by means, for example, one or more of a 3-axis accelerometer, 3-axis gyroscope, 3-axis compass and a barometer. At block 1904, the application 90 creates a geolocalized annotation, associated with the pointed to item. The process then moves to block 1906.

At block 1906, the device 10 starts the gesture recognition, and moves to block 1908, where it is determined by the system of the device, whether the gesture recognition is successful. If no, at block 1908, the process moves to block 1928, where it ends. If yes at block 1908, the gestures of motions in the “X” or “V” shapes, as detected from the wearable device 10, via the device accelerometer as the input sensor. If the “X” gesture is recognized, at block 1912. That is, if the user draws a “X” in the air with the hand wearing the device 10, the device sets the check for the pointed item as “failed”. At block 1910, if a “V” gesture is recognized at block 1914, that is, the user draws a “V” in the air with the hand wearing the device 10, the device 10 sets the check for the pointed item as “passed”.

From blocks 1912 and 1914, the process moves to block 1916, where the device 10, now trained to recognize the “X” gesture as “failed”, and the “V” gesture as “passed”, restarts the gesture recognition. The process moves to block 1918, where the system determines whether the gesture recognition is successful. If not successful at block 1918, the process moves to block 1928, where it ends.

If successful at block 1918, the process moves to block 1920, where the gesture recognized from one of blocks 1912 (X gesture) or 1914 (V gesture), is determined, in order to activate recognition by the system of a “bring to mouth” gesture, that is, the user 11 brings the device 10 close to her mouth, as shown in FIG. 19A-2. If this “bring to mouth” gesture is recognized, the device 10 starts the speech recognition by the device 10, at block 1922. The device 10 uses a microphone (sensor) to receive record the voice of the user, at block 1924, shown as the user dictating a message 1924′ in FIG. 19A-2. The device 10 converts the speech into text and associates the text (and optionally also to the audio) to the annotation, at block 1926. Optionally (but not shown in the diagram of FIG. 19B), the voice input could trigger additional actions, such as, for example, ordering a spare part that is needed to fix an item, fill in a to-do list, or the like. The process moves to block 1928, where it ends.

In the applications of Examples 1-4, the single wave and double wave cause movement move between elements, for example, music tracks or tabs in a cooking app. The present invention comprises also other variants. Alternatively, the user may move her hand from left to right in front of the device 10, e.g., smart phone or wearable (e.g., smart watch, smart band), to move to the next element (e.g., next song or the tab on the right), and move the hand from right to left to move on the previous element (e.g., previous track or the tab on the left). As another alternative, the present invention may use the accelerometer of the device 10 to take input from the user. The user tilts the device 10 on the right side to move on the next element or tilt the device on the right side to move on the previous element. Other alternates may be used to navigate between elements also in two dimension (left, right, up, down) or three dimensions (left, right, up, down, near, far).

### Additional Operations

The present invention is related to processes that allow for multi-modal commands The separation between DSP and handlers decouples the technical aspects related to hardware from design patterns related to OS.

As shown for example, in the system of the device 10 of FIG. 1B, the DSP 40 and handler 60 are connected by way of signal adapters 50. Each signal adapter 50 makes use of a part of DSP 40 functionalities and a subset of the device sensors 15a-15n. The handler 60 makes use of one or more signal adapters 50. Signal adapters 50 allow developers to easily experience various control modes, choose the most suitable for their own purposes and move between different contexts of use. As a result, the present invention includes the following examples of software applications.

A camera software application for water-resistant phones is an example operation in accordance with the present invention. Underwater, the touch screen of the smart phone (device) is unusable and other ways of interaction are needed. Here, the handler includes a signal adapter for blow (blowing of breath by a user) detection, an adapter for inclination detection, an adapter for key-pressing detection, an adapter for object motion detection and an adapter for shake detection. The key pressing detection adapter uses the device profiling database 70 to select the more convenient keys, for example the camera key if present, or the volume key otherwise.

In operation, the user presses the physical key on the smart phone (device 10). The inclination of the phone is detected, and the camera application is launched in a different modality according to the inclination. For example, pressing the key and pointing the phone downwards, launches the camera application with macro feature on; pressing the key and pointing onward, the camera application is launched with standard settings; pressing the key and pointing upward, the camera application is launched in a panorama mode. The above method also operates when the phone has the screen turned off. When the application is open, user waves his hand in front of the phone to take a picture, or holds the hand in front of the phone to swap between front camera and back camera, or shakes the phone to toggle HDR (High-Dynamic-Range) feature.

Another example is a software application (or service) for occupational safety. In the workplace, users often wear gloves and need to call help quickly. In this case, for example, the device 10, such as a smart phone includes a handler with a signal adapter for shaking (including shock and vibration) detection, an adapter for key-pressing detection and an adapter for speech recognition.

The application operates, for example, as follows. Keeping pressed the volume key of the device, e.g., a smart phone, for more than two seconds, the application makes a call to a predefined number (or possibly more than one in sequence, if the called party does not answer). The above example is also suitable for a worker that wants to call help for an unconscious worker quickly. As a variation, pressing the volume key, application launches speech recognition and worker can give commands like: “call X” or “text Y, I am stuck on the second pylon”. If environment is too noisy, the application detects this situation and always directly sends a text message, Short message service (SMS) message or the like, to a security manager, or other designated personnel.

Another example is a camera application to shot “selfies” (pictures of a person or group of people taken by that person or a person in the group of people) quickly and without using the touch screen of the device 10, e.g., a smart phone. This is useful in several contexts, such as, for example, users wearing gloves. The device includes a handler with: 1) a signal adapter for blow detection, 2) an adapter for shake detection, and, 3) an adapter for object motion detection.

The application operates when a user shakes, or otherwise vibrates or shocks smart the phone, the camera application is opened and enters in countdown mode. When the countdown is over, the application shots a picture and enters into a sharing mode. In this mode, if the user blows on the phone, the application shares the picture with other devices; or if the user waves his hand in front of the phone, application enters again in countdown mode; or if the user shakes the phone, the application closes.

Another example application is used for authentication based on motion gestures. The software application or service operates, for example, as follows. The user records a base gesture on the device the first time the application is run. For example the user holds the device (smart phone or smart wearable, as described above) on his hand and records the movement of a pattern in the air, such as a figure eight, or a zig zag pattern.

This application may use the profiling database 70 in order to know the accelerometer accuracy and set a minimum length of the base gesture. Then, when an authentication procedure is required, for example, to unlock the phone or log into your account, the user could repeat the same gesture. Only if this gesture is similar to the base gesture within a certain threshold (that could depend on accelerometer performances fetched by profiling database), the authentication is passed.

Another application is for a city environment, for use by tourists and impaired or physically challenged people, to obtain information about a neighborhood, area, or the like. For example, should a tourist want to know the direction of a famous spot, for example, the Coliseum in Rome, the tourist moves his wristband (wearable device 10 in accordance with that described above in FIGS. 19A-1 and 19A-2) around himself, drawing a circle in the air, parallel to the ground and with him at the center of the circle. When he accidentally points towards the Coliseum (e.g., while pointing towards the South), the device 10 activates a vibration motor to indicate the direction of the desired location, place or the like.

The present disclosure has been described using detailed descriptions of embodiments thereof that are provided by way of example and are not intended to limit the scope of the disclosure. The described embodiments comprise different features, not all of which are required in all embodiments of the disclosure. Some embodiments of the present disclosure utilize only some of the features or possible combinations of the features. Many other ramifications and variations are possible within the teaching of the embodiments comprising different combinations of features noted in the described embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The words “exemplary” and “example” are used herein to mean “serving as an example, instance or illustration”. Any embodiment described as “exemplary” or an “example” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for activating an application comprising:
receiving a request for at least one first group of events, from at least one application;
receiving sensor input from at least one sensor having detected at least one event;
converting the sensor input into data corresponding to the detected at least one event;
associating the data corresponding to each detected event into at least one second group of events;
analyzing the at least one second group of events with the at least one first group of events associated with the request, for determining a correlation therebetween; and,
transmitting a response when there is a correlation between the at least one second group of events and the at least one first group of events associated with the request.

2. The method of claim 1, wherein the at least one first group of events is based on a pattern of events, and the pattern of events is defined by predetermined events.

3. The method of claim 2, wherein the analyzing the at least one second group of events with the at least one first group of events for the correlation therebetween includes analyzing the events of the at least one second group of events with pattern of events, for the correlation.

4. The method of claim 1, wherein the correlation includes at least one of:
matches of the at least one second group of events with the at least one first group of events associated with the request, to at least a predetermined threshold; or,
matches of the at least one second group of events with the pattern of events, to at least a predetermined threshold.

5. (canceled)

6. The method of claim 1, wherein the converting the sensor input into data corresponding to detected events, includes processing the sensor input into signals and converting the signals into the data corresponding to the detected events.

7. The method of claim 1, wherein the at least one sensor includes a plurality of sensors, and the plurality of sensors include one or more of: accelerometers, acceleration sensors, gyroscopes, gyrometers, magnetometers, microphones, proximity sensors, ambient light sensors, Global Positioning System (GPS) sensors, hall effect sensors, magnetic sensors, physical keys on a device touch screen, touch sensors, and, headphone command sensors.

8. (canceled)

9. The method of claim 1, performed on a computerized device, wherein the computerized device is selected from at least one of a smart phone, smart watch, smart band, including a smart wrist band, and, the at least one application is performed on the computerized device.

10-13. (canceled)

14. The method of claim 1, wherein the at least one first group of events and the at least one second group of events each include at least one event.

15. (canceled)

16. The method of claim 14, wherein the event is selected from the group consisting of: a hand gesture, including a hand wave, finger snap or a hand being stationary for a predetermined time period or at a predetermined distance from a reference point, a blow of breath, acceleration of a device, speed of a device, a device position, a device orientation with respect to a reference point, a device location, contact with a touch screen of a device, contact with a physical key of a device, and combinations thereof.

17. (canceled)

18. A system for activating an application comprising:
at least one sensor for detecting events;
a digital signal processor (DSP) in communication with the at least one sensor, the DSP configured for: 1) receiving sensor input from at least one sensor having detected at least one event; 2) converting the sensor input into data corresponding to the detected at least one event; and, 3) associating the data corresponding to each detected event into at least one second group of events; and,
handler control logic in communication with the digital signal processor (DSP) configured for: 1) receiving a request for at least one first group of events, from at least one application; 2) analyzing the at least one second group of events with the at least one first group of events associated with the request, for determining a correlation therebetween; and, 3) transmitting a response when there is a correlation between the at least one second group of events and the at least one first group of events associated with the request.

19. The system of claim 18, wherein the at least one first group of events is based on a pattern of events, and the handler control logic is additionally configured for analyzing the at least one second group of events with the pattern of events, for determining a correlation therebetween.

20. The system of claim 18, wherein the handler control logic is programmed to determine at least one of:
the existence of a correlation when there are matches of the at least one second group of events with the at least one first group of events associated with the request, to at least a predetermined threshold; or,
the existence of a correlation wherein there are matches of the at least one second group of events with the pattern of events, to at least a predetermined threshold.

21. (canceled)

22. The system of claim 18, wherein the DSP is additionally configured for: converting the sensor input into data corresponding to detected events, includes processing the sensor input into signals and converting the signals into the data corresponding to the detected events.

23. The system of claim 18, wherein the at least one sensor includes a plurality of sensors, and the plurality of sensors include one or more of: accelerometers, acceleration sensors, gyroscopes, gyrometers, magnetometers, microphones, proximity sensors, ambient light sensors, Global Positioning System (GPS) sensors, hall effect sensors, magnetic sensors, physical keys on a device touch screen, touch sensors, and, headphone command sensors.

24. (canceled)

25. The system of claim 18 located on a computerized device, and the computerized device is selected from at least one of a smart phone, smart watch, smart band, including a smart wrist band, and the at least one application is on the computerized device.

26-28. (canceled)

29. A computer usable non-transitory storage medium having a computer program embodied thereon for causing a suitable programmed system to activate an application on a device, by performing the following steps when such program is executed on the system, the steps comprising:
receiving a request for at least one first group of events, from at least one application;
receiving sensor input from at least one sensor having detected at least one event;
converting the sensor input into data corresponding to the detected at least one event;
associating the data corresponding to each detected event into at least one second group of events;
analyzing the at least one second group of events with the at least one first group of events associated with the request, for determining a correlation therebetween; and,
transmitting a response when there is a correlation between the at least one second group of events and the at least one first group of events associated with the request.

30. The computer usable non-transitory storage medium of claim 29, wherein the at least one first group of events is based on a pattern of events.

31. The computer usable non-transitory storage medium of claim 30, wherein the analyzing the at least one second group of events with the at least one first group of events for the correlation therebetween includes analyzing the events of the at least one second group of events with pattern of events, for the correlation.

32. The computer usable non-transitory storage medium of claim 29, wherein the correlation includes at least one of:
matches of the at least one second group of events with the at least one first group of events associated with the request, to at least a predetermined threshold; or,
matches of the at least one second group of events with the pattern of events, to at least a predetermined threshold.

33. (canceled)

34. The computer usable non-transitory storage medium of claim 29 wherein the converting the sensor input into data corresponding to detected events, includes processing the sensor input into signals and converting the signals into the data corresponding to the detected events.
